(19) United States
(12) Patent Application Publication
(10) Pub. No.: US 2025/0147182 A1
(43) Pub. Date: May 8, 2025

(54) INFORMATION DETECTION METHOD AND SYSTEM

(71) Applicant: Wuhan VanJee Optoelectronic Technology Co., Ltd., Wuhan (CN)

(72) Inventors: Haiming CHEN, Wuhan (CN); Xuehui SHANG, Wuhan (CN); Yang XU, Wuhan (CN); Juanjuan LI, Wuhan (CN); Yongqiang DENG, Wuhan (CN)

(73) Assignee: Wuhan VanJee Optoelectronic Technology Co., Ltd., Wuhan (CN)

(21) Appl. No.: 18/940,807

(22) Filed: Nov. 7, 2024

(30) Foreign Application Priority Data
Nov. 8, 2023 (CN) 202311490056.5
Dec. 30, 2023 (CN) 202311868597.7
Dec. 30, 2023 (CN) 202311872852.5

(51) Int. Cl. G01S 17/34; H04B 10/079

(52) U.S. Cl. CPC G01S 17/34; H04B 10/079

(57) ABSTRACT

Embodiments of the present application discloses an information detection method and system, the method includes: a first light source generates and divides the first optical signal into a first measurement optical signal and a first reference optical signal, the second light source generates and divides a second optical signal into a second measurement optical signal and a second reference optical signal; performing processing on the first measurement optical signal and second measurement optical signal to obtain a detection optical signal, transmitting the detection optical signal into a detection space and receiving an echo signal; combining the first reference optical signal and the second reference optical signal into a reference optical signal, performing frequency beating on the reference optical signal and the echo signal to obtain a beat frequency signal; determining velocity information and distance information of a detected target based on the beat frequency signal.

### CROSS-REFERENCE TO RELATED APPLICATIONS

This application claims priority to Chinese Patent Application No. 202311868597.7, filed on Dec. 30, 2023, Chinese Patent Application No. 202311872852.5, filed on Dec. 30, 2023 and Chinese Patent Application No. 202311490056.5, filed on Nov. 8, 2023, which are hereby incorporated by reference in their entireties.

### TECHNICAL FIELD

The present application relates to the field of lidar technologies, and in particular, to an information detection method and system.

### BACKGROUND

In the Frequency Modulated Continuous Wave (FMCW) lidar, target detection can be performed by modulating laser of the FMCW lidar, to detect object information of a target object in a specific space, for example, a distance between the lidar and the target object, a moving velocity of the target object, and the like. However, the above target detection mode cannot distinguish the direction of the velocity, which leads to the inability to perform accurate prediction based on the object information and make corresponding processing, for example, performing target interception, target avoidance, and the like.

It can be seen therefrom that in the information detection method in the related art, there is a problem that a direction of the velocity cannot be measured by using a single laser.

### SUMMARY

Embodiments of the present application provides an information detection method and system, so as to at least solve a problem that the velocity direction cannot be measured by using a single laser in related art.

According to an aspect of an embodiment of the present application, an information detection method is provided, including: generating a first optical signal by a first light source and a second optical signal by a second light source, dividing the first optical signal into a first measurement optical signal and a first reference optical signal by the first light source, and dividing the second optical signal into a second measurement optical signal and a second reference optical signal by the second light source; performing delay processing on the first measurement optical signal to obtain a delayed first measurement optical signal, and shifting a frequency of the second measurement optical signal by a specified frequency offset to obtain a frequency-shifted second measurement optical signal; combining the delayed first measurement optical signal and the frequency-shifted second measurement optical signal into a detection optical signal, transmitting the detection optical signal into a detection space and receiving an echo signal; combining the first reference optical signal and the second reference optical signal into a reference optical signal, and performing frequency beating on the reference optical signal and the echo signal to obtain a beat frequency signal; determining velocity information of a detected target based on a first frequency point located in a velocity frequency interval among two frequency points resolved from the beat frequency signal, and determining distance information of the detected target based on a second frequency point located in a distance frequency interval among the two frequency points, where the velocity frequency interval is symmetrical with respect to a frequency point for the specified frequency offset, and the velocity frequency interval and the distance frequency interval do not overlap.

According to another aspect of an embodiment of the present application, an information detection system is provided, including: a first light source, a second light source, a frequency shifter, a delay component, a transceiving module, and a processing module, where the first light source is configured to generate a first optical signal and divide the first optical signal into a first measurement optical signal and a first reference optical signal, the second light source is configured to generate a second optical signal and divide the second optical signal into a second measurement optical signal and a second reference optical signal; the delay component is configured to perform delay processing on the first measurement optical signal to obtain a delayed first measurement optical signal; the frequency shifter is configured to shift a frequency of the second measurement optical signal by a specified frequency offset to obtain a frequency-shifted second measurement optical signal; the transceiving module is configured to combine the delayed first measurement optical signal and the frequency-shifted second measurement optical signal into a detection optical signal, transmit the detection optical signal into a detection space and receive an echo signal; the processing module is configured to combine the first reference optical signal and the second reference optical signal into a reference optical signal, and perform frequency beating on the reference optical signal and the echo signal to obtain a beat frequency signal; determine velocity information of a detected target based on a first frequency point located in a velocity frequency interval among two frequency points resolved from the beat frequency signal, and determine distance information of the detected target based on a second frequency point located in a distance frequency interval among the two frequency points, where the velocity frequency interval is symmetrical with respect to a frequency point for the specified frequency offset, and the velocity frequency interval and the distance frequency interval do not overlap. The velocity frequency interval is symmetrical with respect to the frequency point for the specified frequency offset, the specified frequency offset is greater than or equal to the maximum velocity frequency shift of the velocity measurement laser, and the velocity frequency interval and the distance frequency interval do not overlap; and then the velocity information can be determined based on the velocity measurement frequency point located in the velocity frequency interval among the two frequency points, and the distance information can be determined based on the distance measurement frequency point located in the distance frequency interval among the two frequency points; and the velocity direction is determined according to a magnitude relationship between the velocity frequency point and the specified frequency offset, so only a single processing system (i.e., a single back-end solution system, usually including a balance detector, a single ADC and a single digital signal processor) is needed to resolve the distance, the velocity and the direction, and then the problem in related art that the velocity direction cannot be measured by using a single laser can be solved.

### BRIEF DESCRIPTION OF DRAWINGS

The accompanying drawings herein, which are incorporated in and form a part of the specification, illustrate embodiments in accordance with the present application and, together with the description, serve to explain principles of the present application.

In order to illustrate technical solutions in embodiments of the present application or the prior art more clearly, the accompanying drawings that need to be used in description of the embodiments or the prior art will be briefly introduced below. It is obvious that other accompanying drawings can also be acquired according to these accompanying drawings without paying any creative efforts.

FIG. 1 is a schematic flowchart of an information detection method provided by an embodiment of the present application.

FIG. 2 is a schematic flowchart of another information detection method provided by an embodiment of the present application.

FIG. 3 is a schematic flowchart of yet another optional information detection method provided by an embodiment of the present application.

FIG. 4 is a schematic diagram of yet another optional circulator provided by an embodiment of the present application.

FIG. 5 is a schematic structural diagram of an information detection system provided by an embodiment of the present application.

FIG. 6 is a schematic diagram of yet another information detection method provided by an embodiment of the present application.

FIG. 7 is a schematic diagram of yet another information detection method provided by an embodiment of the present application.

FIG. 8 is a schematic diagram of yet another information detection method provided by an embodiment of the present application.

FIG. 9 is a schematic flowchart of yet another information detection method provided by an embodiment of the present application.

FIG. 10 is a schematic flowchart of yet another information detection method provided by an embodiment of the present application.

FIG. 11 is a schematic structural diagram of another information detection system provided by an embodiment of the present application.

FIG. 12 is a schematic diagram of yet another information detection method provided by an embodiment of the present application.

FIG. 13 is a schematic flowchart of a method for controlling transmission of a laser signal provided by an embodiment of the present application.

FIG. 14 is a schematic diagram of a modulation period of a frequency modulated continuous wave (FMCW) lidar provided by an embodiment of the present application.

FIG. 15 is a schematic flowchart of another method for controlling transmission of a laser signal provided by an embodiment of the present application.

FIG. 16 is a schematic diagram of a scenario of a scanning field of view of a FMCW lidar provided by an embodiment of the present application.

FIG. 17 is a schematic flowchart of yet another method for controlling transmission of a laser signal provided by an embodiment of the present application.

FIG. 18 is a schematic structural diagram of a FMCW lidar provided by an embodiment of the present application.

FIG. 19 is a schematic structural diagram of a first optical coupler provided by an embodiment of the present application.

FIG. 20 is a schematic structural diagram of a circulator provided by an embodiment of the present application.

FIG. 21 is a schematic structural diagram of a second optical coupler provided by an embodiment of the present application.

FIG. 22 is a structural block diagram of an information detection system provided by an embodiment of the present application.

FIG. 23 is a structural block diagram of an information detection system provided by an embodiment of the present application.

FIG. 24 is a structural schematic diagram of an information detection apparatus provided by an embodiment of the present application.

FIG. 25 is a structural schematic diagram of a laser signal transmission control apparatus provided by an embodiment of the present application.

FIG. 26 is a structural block diagram of a computer system of an electronic device provided by an embodiment of the present application.

### DESCRIPTION OF EMBODIMENTS

In order to enable those skilled in the art to better understand solutions of the present application, the technical solutions in the embodiments of the present application will be clearly and completely described below with reference to the accompanying drawings in the embodiments of the present application. It is apparent that the described embodiments are only a part of the embodiments of the present application, rather than all of the embodiments. All other embodiments obtained by a person of ordinary skill in the art based on the embodiments of the present application without paying creative efforts shall fall within the protection scope of the present application.

It should be noted that terms “first”, “second”, and the like in the specification, the claims, and the accompanying drawings above of the present application are used to distinguish similar objects, and are not necessarily used to describe a specific order or sequence. It should be understood that the terms used in this way can be interchanged under appropriate circumstances, so that the embodiments of the present application described herein can be implemented in an order other than those illustrated or described herein. In addition, the terms “include/comprise” and “have” and any deformation thereof are intended to cover a non-exclusive inclusion, for example, processes, methods, systems, products, or devices that include a series of steps or units are not limited to those steps or units listed clearly, but may include other steps or units that are not clearly listed or inherent to these processes, methods, products, or devices.

According to an aspect of an embodiment of the present application, an information detection method is provided. In this embodiment, the above information detection method can be applied to a scenario that needs to detect object information of a target object in a specific space, for example, scenarios for detecting a distance between a laser and the target object, a moving velocity and a velocity direction of the target object, etc.

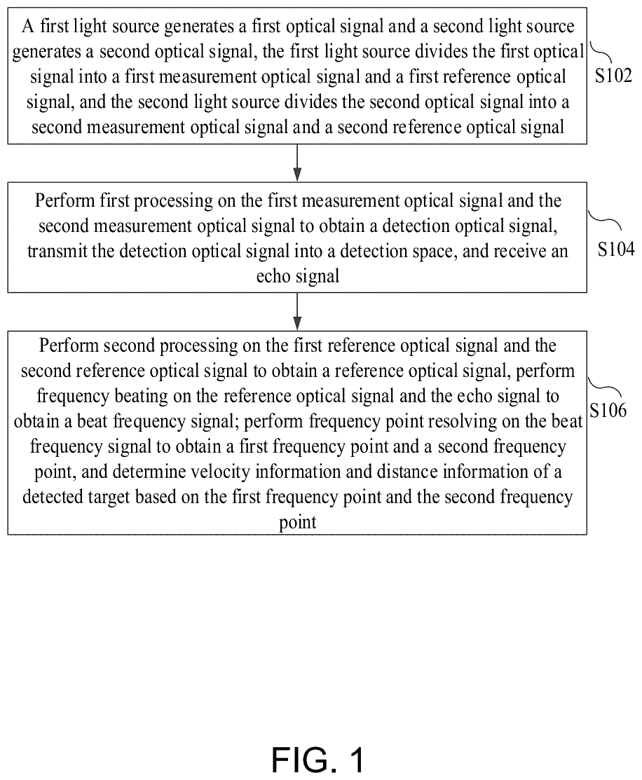

The information detection method of the embodiment of the present application can be executed by an information detection system, which can include a first light source and a second light source, they have different frequencies, a transceiving module and a processing module. The information detection system can be a FMCW lidar, an optical sensor and other types of optical distance measurement device or lidar. An example is taken where the information detection method in this embodiment is executed by the information detection system, FIG. 1 is a schematic flowchart of an information detection method provided by an embodiment of the present application. As shown in FIG. 1, the process of the method can include the following steps:
step S102, a first light source generates a first optical signal and a second light source generates a second optical signal, divides the first optical signal into a first measurement optical signal and a first reference optical signal by the first light source, and divides the second optical signal into a second measurement optical signal and a second reference optical signal by the second light source;
step S104, perform first processing on the first measurement optical signal and the second measurement optical signal to obtain a detection optical signal, transmit the detection optical signal into a detection space, and receive an echo signal; where the first measurement optical signal and the second measurement optical signal are capable of reaching a same object. For example, angle resolution of the lidar is 0.1°, the angle between exit direction of the first measurement optical signal and exit direction of the second measurement optical signal is less than 0.1° in an implementation, to ensure that the first measurement optical signal and the second measurement optical signal reach the same object.
step S106, perform second processing on the first reference optical signal and the second reference optical signal to obtain a reference optical signal, perform frequency beating on the reference optical signal and the echo signal to obtain a beat frequency signal; perform frequency point resolving on the beat frequency signal to obtain a first frequency point and a second frequency point, and determine velocity information and distance information of a detected target based on the first frequency point and the second frequency point.

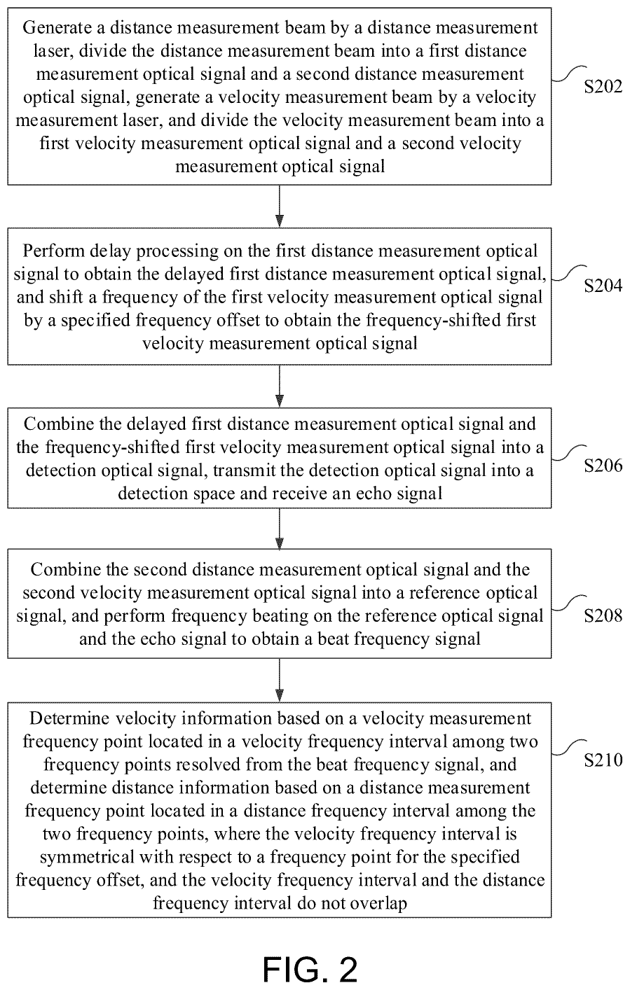

In an implementation of the present application, the first light source includes a first laser and the second light source includes a second laser, and the information detection system further includes a frequency shifter and a delay component, where the first laser is a distance measurement laser used to get the distance of the target in the detection space; and the second laser is a velocity measurement laser used to get the velocity of the target in the detection space. FIG. 2 is a schematic flowchart of an information detection method provided by an embodiment of the present application. As shown in FIG. 2, the process of the method can include the following steps.

Step S202, generate a distance measurement beam (which is a specific example of the first optical signal above) by a distance measurement laser, divide the distance measurement beam into a first distance measurement optical signal and a second distance measurement optical signal (which are specific examples of the first measurement optical signal and first reference optical signal above, respectively), generate a velocity measurement beam (which is a specific example of the second optical signal above) by a velocity measurement laser, and divide the velocity measurement beam into a first velocity measurement optical signal and a second velocity measurement optical signal (which are specific examples of the second measurement optical signal and second reference optical signal above, respectively).

With respect to the distance measurement beam and the velocity measurement beam, they refer to optical signals with specific frequencies or waveforms. Modulation signals of the distance measurement beam and the velocity measurement beam can be triangular wave signals or direct current signals, etc.

In an implementation, the modulation signal of the distance measurement optical signal is a triangular wave signal, and the modulation signal of the velocity measurement optical signal is a direct current signal. It can be understood that both the distance measurement optical signal and the velocity measurement optical signal can also be triangular wave signals, and their working principles are similar to the former case, which are not repeated here again.

Here the division of the distance measurement beam into the first distance measurement optical signal and the second distance measurement optical signal, as well as the division of the velocity measurement beam into the first velocity measurement optical signal and the second velocity measurement optical signal, both can be realized by beam splitter. It should be noted that the beam splitter is an optical device that divides an input beam into multiple parallel output beams.

In an implementation, generating the distance measurement beam by the distance measurement laser, dividing the distance measurement beam into the first distance measurement optical signal and the second distance measurement optical signal, generating the velocity measurement beam by the velocity measurement laser, and dividing the velocity measurement beam into the first velocity measurement optical signal and the second velocity measurement optical signal include:
generating the distance measurement beam by the distance measurement laser, and generating the velocity measurement beam by the velocity measurement laser;
dividing the distance measurement beam by a first beam splitter into the first distance measurement optical signal and the second distance measurement optical signal, and dividing the velocity measurement beam by a second beam splitter into the first velocity measurement optical signal and the second velocity measurement optical signal.

In this embodiment, the first light source may include the first beam splitter and the second light source may include the second beam splitter. The distance measurement beam is generated by the distance measurement laser, and the distance measurement beam is divided into the first distance measurement optical signal and the second distance measurement optical signal by the first beam splitter; and the velocity measurement beam is generated by the velocity measurement laser, and the velocity measurement beam is divided into the first velocity measurement optical signal and the second velocity measurement optical signal by the second beam splitter.

It should be noted that, in this embodiment, the beam splitter can be a 1×2 coupler, which is configured to split a specific input beam into two parallel output beams. The steps of this embodiment can be jointly performed by the first beam splitter and the second beam splitter.

In the implementation, performing first processing on the first measurement optical signal and the second measurement optical signal to obtain the detection optical signal includes the following step.

Step S204, perform delay processing on the first distance measurement optical signal to obtain the delayed first distance measurement optical signal, and shift a frequency of the first velocity measurement optical signal by a specified frequency offset to obtain the frequency-shifted first velocity measurement optical signal.

In the implementation, performing delay processing on the first distance measurement optical signal to obtain the delayed first distance measurement optical signal can be realized by connecting a delay optical fiber (which is a specific example of the delay component above) in series in an optical path of the first distance measurement optical signal. The delay optical fiber can change an optical path difference, thus changing the frequency of the first distance measurement optical signal. Here, performing delay processing on the first distance measurement optical signal can be increasing the frequency of the first distance measurement optical signal.

With respect to the shifting of the frequency of the first velocity measurement optical signal by the specified frequency offset, for example, if the specified frequency offset is A, then shifting the frequency of the first velocity measurement optical signal by A to obtain the frequency-shifted first velocity measurement optical signal can be realized by connecting a frequency shifter in series in an optical path of the first velocity measurement optical signal. The frequency shifter can change the frequency of the first velocity measurement optical signal; the specified frequency offset is greater than or equal to the maximum velocity shift of the velocity measurement laser, so as to ensure that the first frequency point in the beat frequency signal is within an interval greater than 0.

In an implementation, the lowest frequency point of the delayed first distance measurement optical signal exceeds twice the specified frequency offset, which can ensure that a frequency interval where the first distance measurement optical signal is located does not overlap with a frequency interval where the first velocity measurement optical signal is located, thus making it easier to distinguish a velocity measurement frequency point (which is a specific example of the first frequency point above) located in the velocity frequency interval from a distance measurement frequency point (which is a specific example of the second frequency point above).

The information detection system can include the delay component and the frequency shifter. The delay component is configured to perform delay processing on the first distance measurement optical signal to obtain the delayed first distance measurement optical signal. The frequency shifter is configured to shift the frequency of the first velocity measurement optical signal by the specified frequency offset to obtain the frequency-shifted first velocity measurement optical signal. Step S204 can be jointly performed by the delay component and the frequency shifter.

In the implementation, performing first processing on the first measurement optical signal and the second measurement optical signal to obtain the detection optical signal further includes the following step.

Step S206, combine the delayed first distance measurement optical signal and the frequency-shifted first velocity measurement optical signal into a detection optical signal, transmit the detection optical signal into a detection space and receive an echo signal.

Combining the delayed first distance measurement optical signal and the frequency-shifted first velocity measurement optical signal into the detection optical signal can be realized by a beam combiner, which can couple the first distance measurement optical signal and the first velocity measurement optical signal into a detection optical signal.

After the detection optical signal is transmitted into the detection space, the detection optical signal can be transmitted into the detection space. When there is a target object in the detection space, part of the detection optical signal will be reflected by the target object after the detection optical signal after reaching the target object, and the information detection system can receive the reflected echo signal. For example, the information detection system can be a vehicle-mounted FMCW lidar, and the application scenario can be a scenario where a car is driving on a highway. The vehicle-mounted FMCW lidar transmits a detection optical signal forward, and the detection optical signal is reflected back after it contacts with the vehicle in front, and the vehicle-mounted FMCW radar can receive the echo signal.

The information detection system can include a transceiving module, which is configured to combine the delayed first distance measurement optical signal and the frequency-shifted first velocity measurement optical signal into a detection optical signal, transmit the detection optical signal into the detection space, and receive the echo signal. Step S206 can be performed by the transceiving module.

In the implementation, performing second processing on the first reference optical signal and the second reference optical signal to obtain the reference optical signal includes the following steps.

Step S208, combine the second distance measurement optical signal and the second velocity measurement optical signal into a reference optical signal, and perform frequency beating on the reference optical signal and the echo signal to obtain a beat frequency signal.

Combining the second distance measurement optical signal an d the second velocity measurement optical signal into the reference optical signal and performing frequency beating on the reference optical signal and the echo signal to obtain the beat frequency signal can be combining the second distance measurement optical signal and the second velocity measurement optical signal into the reference optical signal by the beam combiner.

The information detection system can include a processing module for performing frequency beating on the reference optical signal and the echo signal to obtain the beat frequency signal. Step 1208 can be performed by the processing module.

In the implementation, performing frequency point resolving on the beat frequency signal to obtain the first frequency point (i.e., velocity measurement frequency point) and the second frequency point (i.e., distance measurement frequency point), and determining the velocity information and the distance information of the detected target based on the first frequency point and the second frequency point include the following step.

Step S210, determine velocity information based on a velocity measurement frequency point located in a velocity frequency interval among two frequency points resolved from the beat frequency signal, and determine distance information based on a distance measurement frequency point located in a distance frequency interval among the two frequency points, where the velocity frequency interval is symmetrical with respect to a frequency point for the specified frequency offset, and the velocity frequency interval and the distance frequency interval do not overlap.

For the two frequency points resolved from the beat frequency signal, the two frequency points can be obtained by performing frequency point resolving on the beat frequency signal, for example, a digital signal can be obtained by performing analog-to-digital conversion on the beat frequency signal, and two frequency points can be obtained by performing fast Fourier transform on the digital signal. Due to the differentiation of frequencies of the first distance measurement optical signal and the first velocity measurement optical signal in step S204, the two frequency points resolved from the beat frequency signal are located in the velocity frequency interval and the distance frequency interval respectively, so the velocity information can be determined from the velocity measurement frequency point located in the velocity frequency interval among the two frequency points resolved from the beat frequency signal, and the distance information can be determined based on the distance measurement frequency point located in the distance frequency interval among the two frequency points.

Here, the velocity information can include a moving velocity of the detected target and a velocity direction of the moving velocity of the detected target, and the distance information can include a distance between the lidar and the detected target.

The information detection system can include a processing module, which is configured to determine the velocity information and the distance information based on the two frequency points resolved from the beat frequency signal, Step S210 can be performed by the processing module.

In an implementation, determining the velocity information based on a velocity measurement frequency point located in the velocity frequency interval among the two frequency points resolved from the beat frequency signal, and determining the distance information based on the distance measurement frequency point located in the distance frequency interval among the two frequency points include:
determining the velocity information by dividing a product of the velocity measurement frequency point and a central wavelength of the velocity measurement laser by 4;
determining the distance information by dividing a product of the distance measurement frequency point, a velocity of light and a target modulation period by a product of 4 and a target modulation bandwidth;
where the target modulation period is a modulation period corresponding to the detection optical signal, and the target modulation bandwidth is a modulation bandwidth corresponding to the detection optical signal.

The processing module can include a digital signal processor, which is configured to determine the velocity information and the distance information respectively according to the velocity measurement frequency point and the distance measurement frequency point, and step S210 can be performed by the digital signal processor.

According to the embodiment provided by the present application, the distance measurement beam is generated by the distance measurement laser, the distance measurement beam is divided into the first distance measurement optical signal and the second distance measurement optical signal, the velocity measurement beam is generated by the velocity measurement laser, and the velocity measurement beam is divided into the first velocity measurement optical signal and the second velocity measurement optical signal; delay processing is performed on the first distance measurement optical signal to obtain the delayed first distance measurement optical signal, and a frequency of the first velocity measurement optical signal is shifted by the specified frequency offset to obtain the frequency-shifted first velocity measurement optical signal; the delayed first distance measurement optical signal and the frequency-shifted first velocity measurement optical signal are combined into the detection optical signal, the detection optical signal is transmitted into the detection space and the echo signal is received; the second distance measurement optical signal and the second velocity measurement optical signal are combined into the reference optical signal, and frequency beating is performed on the reference optical signal and the echo signal to obtain the beat frequency signal; the velocity information is determined based on the velocity measurement frequency point located in the velocity frequency interval among the two frequency points resolved from the beat frequency signal, and the distance information is determined based on the distance measurement frequency point located in the distance frequency interval among the two frequency points, where the velocity frequency interval is symmetrical with respect to the frequency point for the specified frequency offset, the specified frequency offset is greater than or equal to the maximum velocity frequency shift of the velocity measurement laser, and the velocity frequency interval and the distance frequency interval do not overlap; and then the velocity information can be determined based on the velocity measurement frequency point located in the velocity frequency interval among the two frequency points, and the distance information can be determined based on the distance measurement frequency point located in the distance frequency interval among the two frequency points; and the velocity direction is determined according to a magnitude relationship between the velocity frequency point and the specified frequency offset, so only a single processing system (i.e., a single back-end solution system, usually including a balance detector, a single ADC and a single digital signal processor) is needed to resolve the distance, the velocity and the direction, and then the problem in related art that the velocity direction cannot be measured by using a single laser can be solved.

As a solution, after combining the second distance measurement optical signal and the second velocity measurement optical signal into the reference optical signal, and performing frequency beating on the reference optical signal and the echo signal, the method further includes:
S11, performing fast Fourier transform on the beat frequency signal of one signal period by using a sliding window with a preset size to obtain a set of sub-frequency signals, where each sub-frequency signal in the set of sub-frequency signals corresponds to a signal located in the sliding window after one sliding in the beat frequency signal of the one signal period;
S12, performing peak searching processing on the set of sub-frequency signals to obtain the velocity measurement frequency point and the distance measurement frequency point.

In this embodiment, a length of the sliding window with the preset size is less than a length of the sliding window after one sliding, that is, the long-window fast Fourier transform can be performed on the beat frequency signal first, and then, the short-window fast Fourier transform is used, and the long-window fast Fourier transform can limit a peak searching interval of the short-window fast Fourier transform, thereby reducing the peak searching interval, reducing interference and improving the accuracy of information detection.

The information detection system can include a processing module, which is configured to perform fast Fourier transform on the beat frequency signal to obtain the set of sub-frequency signals, obtain the velocity measurement frequency point and the distance measurement frequency point based on the set of sub-frequency signals. The steps of this embodiment can be performed by the processing module.

According to this embodiment, the peak searching interval can be limited by performing the fast Fourier transform on the beat frequency signal of the one signal period with the sliding window with the preset size, so as to reduce interference and improve the accuracy of information detection.

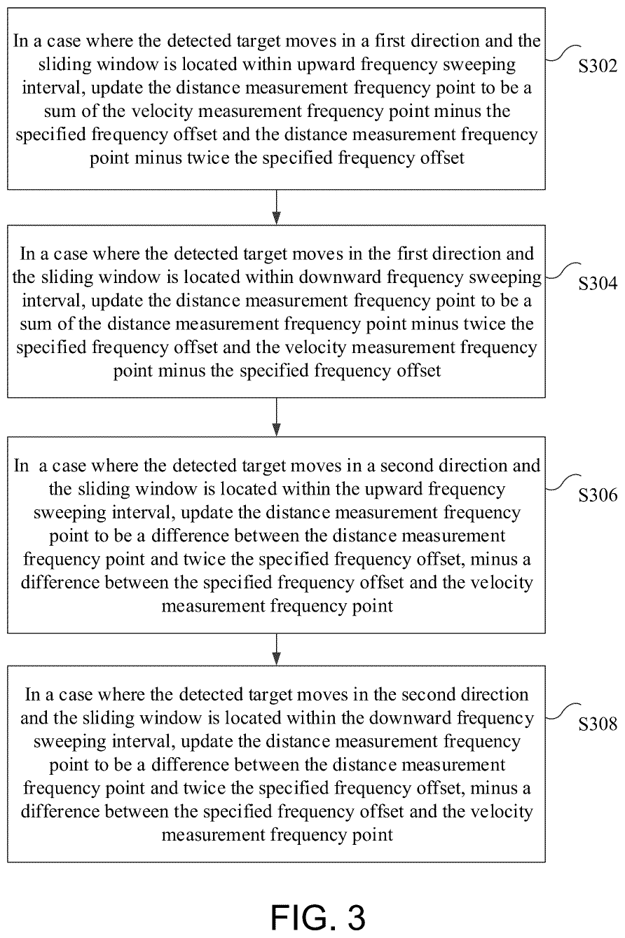

As a solution, refer to FIG. 3, FIG. 3 is a schematic flowchart of another information detection method provided by an embodiment of the present application. As shown in FIG. 3, after performing peak searching processing on the set of sub-frequency signals to obtain the velocity measurement frequency point and the distance measurement frequency point, the method further includes:
step S302, in a case where the detected target moves in a first direction and the sliding window is located within upward frequency sweeping interval, update the distance measurement frequency point to be a sum of the velocity measurement frequency point minus the specified frequency offset and the distance measurement frequency point minus twice the specified frequency offset;
step S304, in a case where the detected target moves in the first direction and the sliding window is located within downward frequency sweeping interval, update the distance measurement frequency point to be a sum of the distance measurement frequency point minus twice the specified frequency offset and the velocity measurement frequency point minus the specified frequency offset;
step S306, in a case where the detected target moves in a second direction and the sliding window is located within the upward frequency sweeping interval, update the distance measurement frequency point to be a difference between the distance measurement frequency point and twice the specified frequency offset, minus a difference between the specified frequency offset and the velocity measurement frequency point;
step S308, in a case where the detected target moves in the second direction and the sliding window is located within the downward frequency sweeping interval, update the distance measurement frequency point to be a difference between the distance measurement frequency point and twice the specified frequency offset, minus a difference between the specified frequency offset and the velocity measurement frequency point.

Among them, the upward frequency sweeping interval means a signal segment where the frequency changes from low to high, and the downward frequency sweeping interval means a signal segment where the frequency changes from high to low.

Among them, the first direction is a direction along which the detected target moves away from the second light source (or the velocity measurement laser), and the second direction is a direction along which the detected target approaches the velocity measurement laser.

In an implementation, before performing step S302, the solution of this embodiment can further include determining the velocity direction of the moving velocity of the detected target based on the relationship between the velocity measurement frequency point and the specified frequency offset: in a case where the velocity measurement frequency point is greater than the specified frequency offset, determining the velocity direction of the moving velocity of the detected target as the first direction; in a case where the velocity measurement frequency point is less than the specified frequency offset, determining the velocity direction of the moving velocity of the detected target as the second direction.

In this embodiment, frequency sweeping refers to a process in which the frequency of a signal changes continuously from high to low (or from low to high) within a frequency band; the sliding window being located within the upward frequency sweeping interval means that the sliding window is located within a signal segment where the frequency changes from low to high, the sliding window being located within the downward frequency sweeping interval means that the sliding window is located within a signal segment where the frequency changes from high to low.

The steps of this embodiment can be performed by the processing module. The processing module can include a digital signal processor, which is configured to determine the distance measurement frequency point according to the velocity direction of the moving velocity of the detected target and a position of the sliding window in the beat frequency signal. The steps of this embodiment can be performed by the digital signal processor.

According to this embodiment, the distance measurement frequency point is determined according to the velocity direction of the moving velocity of the detected target and the position of the sliding window in the frequency sweeping interval, which can improve the accuracy of determining the distance measurement frequency point.

As a solution, optical power of the first distance measurement optical signal is greater than that of the second distance measurement optical signal, and optical power of the first velocity measurement optical signal is greater than that of the second velocity measurement optical signal.

In this embodiment, a first ratio of the optical power of the first distance measurement optical signal to the optical power of the second distance measurement optical signal can be 90:10; a second ratio of the optical power of the first velocity measurement optical signal to the optical power of the second velocity measurement optical signal can be 90:10.

By setting the optical power of the first distance measurement optical signal to be greater than that of the second distance measurement optical signal, and the optical power of the first velocity measurement optical signal to be greater than that of the second velocity measurement optical signal, the accuracy of the information detection method can be improved. It should be noted that the first ratio and the second ratio shall not be limited here.

As a solution, combining the second distance measurement optical signal and the second velocity measurement optical signal into the reference optical signal, and performing frequency beating on the reference optical signal and the echo signal to obtain the beat frequency signal include:
S21, a first beam combiner combines the second distance measurement optical signal and the second velocity measurement optical signal into the reference optical signal; a second beam combiner combines the reference optical signal and the echo signal, and perform frequency beating on the reference optical signal and the echo signal in the second beam combiner to obtain the beat frequency signal, where the beat frequency signal is provided to the balance detector by the second beam combiner.

After performing frequency beating on the reference optical signal and the echo signal, the method further includes:
S22, the balance detector and an analog-to-digital converter perform photoelectric conversion and analog-to-digital conversion on the beat frequency signal in turn to obtain the velocity measurement frequency point and the distance measurement frequency point.

In this embodiment, the first beam combiner can be a 2×1 coupler configured to couple two beams into one beam. The second beam combiner can be a 2×2 coupler or mixer, which is configured to perform frequency beating on the echo signal by using the reference path optical signal as a local oscillator signal to obtain the beat frequency signal, and provide the beat frequency signal to the balance detector.

The processing module can also include an ADC (Analog-to-Digital Converter) and a digital signal processor. The second beam combiner provides the beat frequency signal to the balance detector, the balance detector performs photoelectric conversion on the beat frequency signal to obtain an electrical signal. The ADC performs analog-to-digital conversion on the electrical signal to obtain a digital signal (to obtain the velocity measurement frequency point and the distance measurement frequency point). The digital signal processor performs processing based on the digital signal to obtain the velocity information and the distance information.

The processing module can include the first beam combiner, the second beam combiner, the balance detector and the analog-to-digital converter, the steps of this embodiment can be jointly performed by the first beam combiner, the second beam combiner, the balance detector and the analog-to-digital converter.

According to this embodiment, the beat frequency signal is obtained by the second beam combiner, and the velocity measurement frequency point and the distance measurement frequency point are determined based on the beat frequency signal, so that the information detection efficiency of the information detection method can be improved.

As a solution, combining the delayed first distance measurement optical signal and the frequency-shifted first velocity measurement optical signal into the detection optical signal, transmitting the detection optical signal into the detection space include:
S31, combining the delayed first distance measurement optical signal and the frequency-shifted first velocity measurement optical signal into the detection optical signal;
S32, inputting the detection optical signal into a first port of a circulator, transmitting the detection optical signal into the detection space by a collimator connected to a second port of the circulator, and receiving the echo signal by the collimator; or,
S33, inputting the detection optical signal into a first port of a circulator, transmitting the detection optical signal into the detection space by an optical phase array connected to a second port of the circulator, and receiving the echo signal by the optical phase array.

In this embodiment, the transceiving module can include a third beam combiner, the circulator and the collimator, the third beam combiner is configured to combine the delayed first distance measurement optical signal and the frequency-shifted first velocity measurement optical signal into the detection optical signal, and transmit the detection optical signal to the circulator; the circulator is configured to output the detection optical signal input through the first port of the circulator to the collimator through the second port of the circulator, the collimator is configured to transmit the detection optical signal into the detection space and receive the echo signal. In other embodiments, the transceiving module can also include a third beam combiner, a circulator and an optical phase array, the third beam combiner is configured to combine the delayed first distance measurement optical signal and the frequency-shifted first velocity measurement optical signal into the detection optical signal, the circulator is configured to output the detection optical signal input through the first port of the circulator to the optical phase array through the second port of the circulator, the optical phase array is configured to transmit the detection optical signal into the detection space and obtain the echo signal.

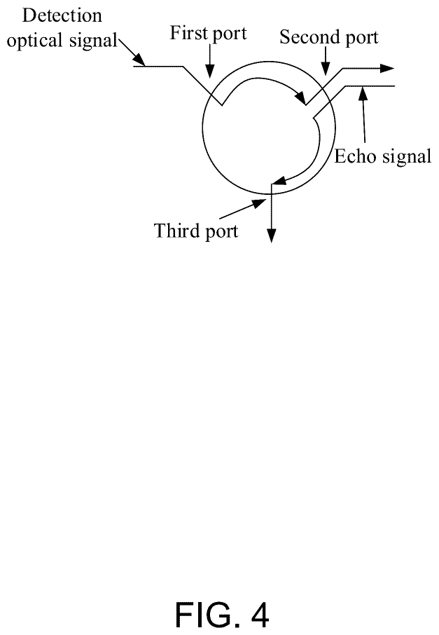

It should be noted that, refer to FIG. 4, FIG. 4 is a schematic diagram of an optional circulator according to an embodiment of the present application. As shown in FIG. 4, the circulator is a multi-port optical device with a non-reciprocal characteristic. When an optical signal is input from any port, it is output from a next port in numerical order with minimal loss, a signal is input from port 1, and the signal can only be output from port 2; similarly, a signal input from the port 2 can only be output from port 3. In order to transmit the detection optical signal into the detection space, the detection optical signal can be input to the first port of the circulator, the circulator outputs the detection optical signal from the second port of the circulator to a collimator, the collimator is configured to transmit the detection optical signal into the detection space and receive the echo signal, and the echo signal can be input to the second port of the circulator and output from the third port of the circulator. Here, the collimator belongs to an optical element of the optical fiber communication optical device for inputting and outputting, and the collimator is a commonly used optical device, which is not described in detail here again.

According to this embodiment, the echo signal is obtained based on the detection optical signal, and the information detection efficiency of the information detection method can be improved.

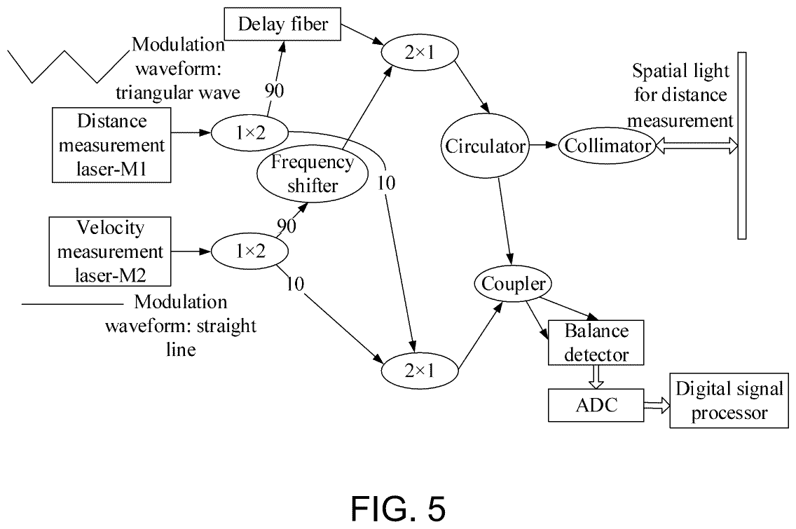

The information detection method in this embodiment is explained below with reference to examples. In this example, the information detection method can be performed by an information detection system, refer to FIG. 5, FIG. 5 a schematic structural diagram of an optional information detection system according to an embodiment of the present application. As shown in FIG. 5, the information detection system includes a distance measurement laser M1, a velocity measurement laser M2, two 1×2 couplers, two 2×1 couplers, a frequency shifter, a delay optical fiber, a circulator, a collimator, a 2×2 coupler, a balance detector, an ADC and a digital signal processor.

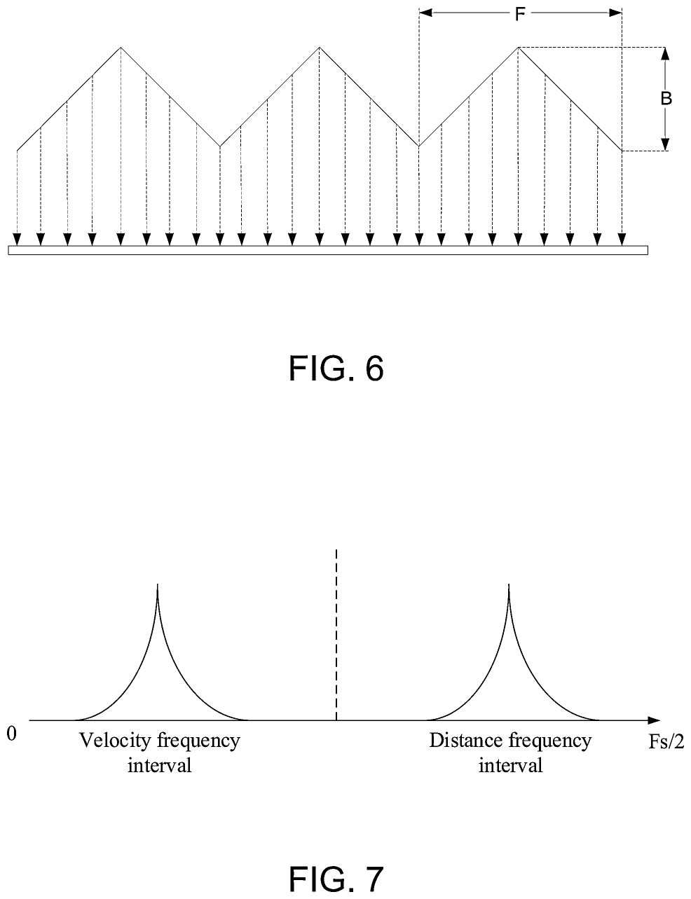

The distance measurement laser M1 performs modulation with a high power, a long period and a wide bandwidth, for example, 25K-8G, refer to FIG. 6, where F=25K and B=8G in FIG. 6, where F represents the modulation rate, and B represents the modulation bandwidth. Here, a digital signal processor is responsible for the distance measurement and resolving, and the short-window fast Fourier transform is used. As shown in FIG. 6, an entire waveform is segmented according to segmenting lines at a time-frequency signal of 25K-8G (for example, in FIG. 6, one period of a 40 s period signal is divided into 8 parts, and each part lasts 5 μs, that is, an operation of a short window fast Fourier transform can thus be performed), in this way, both the resolving precision and the point frequency can be ensured with the help of the subsequent long and short window FFT algorithm.

The velocity measurement laser M2 performs modulation based on the direct current modulation waveform to realize the measurement of the velocity of the detected target.

The 1×2 coupler is configured to divide one laser beam into two laser beams.

The 2×1 coupler is configured to combine two laser beams into one laser beam.

Assuming that the frequency of the first velocity measurement optical signal emitted by the velocity measurement laser M2 is f0, the frequency of the first velocity measurement optical signal f0 is shifted by frequency A by the frequency shifter, the determination of the velocity direction of the moving velocity of the detected target is based on the direction of the velocity measurement frequency point relative to the frequency point A. if the velocity measurement frequency point is greater than the frequency A, the velocity is positive, that is, the detected target is in a direction away from the velocity measurement laser, otherwise, the velocity is negative.

In this embodiment, the information detection method includes: the distance measurement laser M1 performs a forward triangular wave modulation, and the velocity measurement laser M2 performs modulation with a direct current modulation waveform. For the distance measurement laser M1, after modulation (the modulation signal used is a triangular wave signal), a distance measurement beam is generated, and the distance measurement beam is divided into a first distance measurement optical signal and a second distance measurement optical signal by a 1×2 coupler (in practice, the optical power of the second distance measurement optical signal is less than that of the first distance measurement optical signal, for example, the ratio of the optical power of the second distance measurement optical signal to the optical power of the first distance measurement optical signal is 10:90). For the velocity measurement laser M2, a velocity measurement beam is divided into a first velocity measurement optical signal and a second velocity measurement optical signal by a 1×2 coupler (in practice, the optical power of the second velocity measurement optical signal is less than that of the first velocity measurement optical signal, for example, the ratio of the optical power of the second velocity measurement optical signal to the optical power of the first velocity measurement optical signal is 10:90). Among them, refer to FIG. 7, a delay optical fiber with a certain length is connected in series in the optical path of the first distance measurement optical signal, the delay optical fiber can change the optical path difference, and the frequency of the first distance measurement optical signal transmitted can be changed through the optical path difference, thereby changing the frequency of the distance measurement frequency point to separate the velocity frequency interval from the distance frequency interval, because if the two overlap, it may be impossible to distinguish the velocity measurement frequency point from the distance measurement frequency point; a frequency shifter is connected in series in the optical path of the first velocity measurement optical signal, and its function is to map the velocity measurement frequency point into a frequency interval in which a direction can be distinguished, in order to realize calculation of the velocity and direction within one period.

Among them, the first distance measurement optical signal and the first velocity measurement optical signal are combined by the 2×1 coupler (which is a specific example of the third beam combiner above) into the detection optical signal and the detection optical signal is input to the first port of the circulator, and then output to the detection space through the collimator connected to the second port of the circulator for distance measurement; after being reflected by the detected target, the signal is also received by the collimator and then passes through the third port of the circulator to output the echo signal, and here, the detection optical signal can also be input to the optical phase array for distance measurement.

The second distance measurement optical signal generated by the distance measurement laser M1 and the second velocity measurement optical signal generated by the velocity measurement laser M2 are combined by the 2×1 coupler (which is a specific example of the first beam combiner above) into the reference optical signal, the reference optical signal and the echo signal are subject to frequency mixing or frequency beating by the 2×2 coupler (which is a specific example of the second beam combiner above) to obtain the beat frequency signal, the beat frequency signal is input into the balance detector and converted into an electrical signal, the electrical signal is input into the ADC and converted into a digital signal, and the ADC inputs the digital signal to the digital signal processor for processing.

For the resolving of velocity and distance, firstly, a short window fast Fourier transform is performed on the beat frequency signal to obtain a resolving result, then peak searching is performed, a velocity measurement frequency point Fc and a distance measurement frequency point Fd are determined firstly, and resolving is performed after the frequency points in two intervals are determined.

For the resolving of velocity, firstly, the velocity direction of the moving velocity of the detected target is determined according to the magnitude relationship between the velocity measurement frequency point Fc and the frequency A. If the velocity measurement frequency point is greater than the frequency A (as a frequency offset), the velocity is positive, that is, the detected target is in a direction away from the velocity measurement laser, otherwise, it is negative. The magnitude of the moving velocity of the detected target is calculated according to Formula (1), where Fc has been updated by eliminating the frequency offset A:

$$V = \frac{λ}{4} * {F}_{c} . \qquad ( 1 )$$

For the solving of distance value, firstly, the distance measurement frequency point Fd is updated according to the velocity direction to obtain a frequency point for distance solving (i.e., updated distance measurement frequency point), which specifically includes the following four situations. If the velocity direction is positive, the short window is located within the upward frequency sweeping interval, and the frequency point for distance solving is updated to (F_{c}−A)+(F_{d}−2A); the distance between the detected target and the laser is

$$R = \frac{CT}{4 B} ( ( {F}_{c} - A ) + ( {F}_{d} - 2 A ) ) .$$

If the velocity direction is positive, the short window is located within the downward frequency sweeping interval, and the frequency point for distance solving is updated to (F_{d}−2A)−(F_{c}−A), the distance between the detected target and the laser is

$$R = \frac{CT}{4 B} ( ( {F}_{d} - 2 A ) - ( {F}_{c} - A ) ) .$$

If the velocity direction is negative, the short window is located within the upward frequency sweeping interval, and the frequency point for distance solving is updated to (F_{d}−2A)−(A−F_{c}), the distance between the detected target and the laser is

$$R = \frac{CT}{4 B} ( ( {F}_{d} - 2 A ) - ( A - {F}_{c} ) ) .$$

If the velocity direction is negative, the short window is located within the downward frequency sweeping interval, and the frequency point for distance solving is updated to (F_{d}−2A)+(A−F_{c}), the distance between the detected target and the laser is

$$R = \frac{CT}{4 B} ( ( {F}_{d} - 2 A ) + ( A - {F}_{c} ) ) .$$

In the above description, X is the central wavelength of the laser, C is the velocity of light, B is the modulation bandwidth, and T is the modulation period.

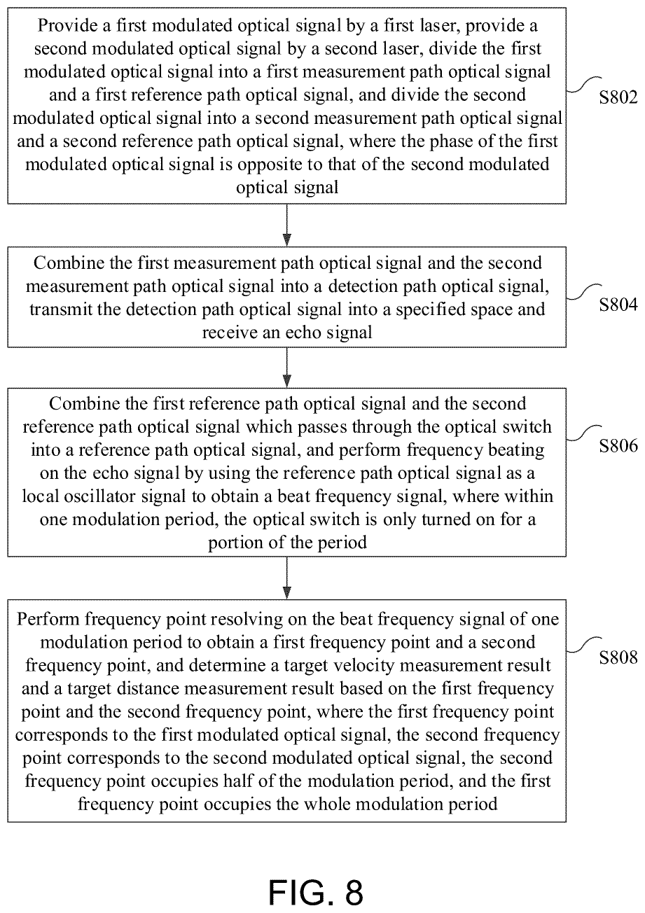

In another implementation of the present application, the light source includes a first light source and a second light source, the first light source includes a first laser and the second light source includes a second laser, and the information detection system further includes an optical switch. FIG. 8 is a schematic flowchart of an information detection method provided by an embodiment of the present application. As shown in FIG. 8, the process of the method can include the following steps.

Step S802, provide a first modulated optical signal (which is a specific example of the first optical signal above) by a first laser, provide a second modulated optical signal (which is a specific example of the second optical signal above) by a second laser, divide the first modulated optical signal into a first measurement path optical signal and a first reference path optical signal (which are specific examples of the first measurement optical signal and first reference optical signal above, respectively), and divide the second modulated optical signal into a second measurement path optical signal and a second reference path optical signal (which are specific examples of the second measurement optical signal and second reference optical signal above, respectively), where the phase of the first modulated optical signal is opposite to that of the second modulated optical signal.

The first light source can generate the first modulated optical signal and the second light source can generate the second modulated optical signal. Here, the first modulated optical signal and the second modulated optical signal refer to optical signals with specific frequencies or specific waveforms, and the modulated optical signal can be a triangular wave signal or a direct current signal.

With respect to the division of the first modulated optical signal into the first measurement path optical signal and the first reference path optical signal, as well as the division of the second modulated optical signal into the second measurement path optical signal and the second reference path optical signal, the manner of dividing the modulated optical signal into the measurement path optical signal and the reference path optical signal here can be realized by inputting the modulated optical signal into a beam splitter, which divides the modulated optical signal into the measurement path optical signal and the reference path optical signal.

The information detection system can include a light source, which is configured to provide the first modulated optical signal and the second modulated optical signal, divide the first modulated optical signal into the first measurement path optical signal and the first reference path optical signal, and divide the second modulated optical signal into the second measurement path optical signal and the second reference path optical signal. Step S802 can be performed by the light source.

Step S804, combine the first measurement path optical signal and the second measurement path optical signal into a detection path optical signal (which is a specific example of the detection optical signal above), transmit the detection path optical signal into a specified space (which is also referred to as detection space herein) and receive an echo signal.

After obtaining the first measurement path optical signal and the second measurement path optical signal, the two can be combined into the detection path optical signal, which can be realized by a beam combiner.

After being emitted into the detection space, the detection optical signal transmits in the detection space. When there is a target object in the detection space, part of the detection optical signal will be reflected by the target object after the detection optical signal reaches the target object to form the echo signal, and the information detection system can receive the reflected echo signal. For example, the information detection system can be a vehicle-mounted FMCW lidar, and the application scenario can be a scenario where a car is driving on a highway. The vehicle-mounted FMCW lidar transmits a detection optical signal forward, and the detection optical signal is reflected back after it contacts with the vehicle in front to form the echo signal, and the vehicle-mounted FMCW lidar can receive the echo signal, and determine the target based on the echo signal.

The information detection system can include a transceiving module, which is configured to combine the first measurement path optical signal and the second measurement path optical signal into a detection path optical signal, transmit the detection path optical signal into the specified space, and receive the echo signal. Step S804 can be performed by the transceiving module. For example, the transceiving module can be a phased array antenna, a lens module, or an MEMS (Micro Electro Mechanical Systems) mirror.

In the implementation, performing second processing on the first reference optical signal and the second reference optical signal to obtain the reference optical signal includes the following steps.

Step S806, combine the first reference path optical signal and the second reference path optical signal which passes through the optical switch into a reference path optical signal, and perform frequency beating on the echo signal by using the reference path optical signal as a local oscillator signal to obtain a beat frequency signal, where within one modulation period, the optical switch is only turned on for a portion of the period.

The optical switch can control the on-off of the first reference path optical signal. When the optical switch is turned on, the reference path optical signal is obtained by combining the first reference path optical signal and the second reference path optical signal which passes through the optical switch; and when the optical switch is turned off, the reference path optical signal is composed of the first reference path optical signal. The optical switch here can be an optical switch capable of achieving turn-off functions within microseconds.

In this embodiment, within one modulation period, the optical switch is only turned on for a portion of the period, that is, the optical switch can be turned on within a first half of the one modulation period and turned off within a second half of the one modulation period; or the optical switch can be turned on within the second half of the one modulation period and turned off within the first half of the one modulation period.

The information detection system can include a processing module, which is configured to perform frequency beating on the echo signal with the reference path optical signal as a local oscillator signal to obtain the beat frequency signal. The step S806 can be performed by the processing module.

In the implementation, performing frequency point resolving on the beat frequency signal to obtain the first frequency point and the second frequency point, and determining the velocity information and the distance information of the detected target based on the first frequency point and the second frequency point include the following step.

Step S808, perform frequency point resolving on the beat frequency signal of one modulation period to obtain a first frequency point and a second frequency point, and determine a target velocity measurement result and a target distance measurement result (which are specific examples of the velocity information and distance information above, respectively) based on the first frequency point and the second frequency point, where the first frequency point corresponds to the first modulated optical signal, the second frequency point corresponds to the second modulated optical signal, the second frequency point occupies half of the modulation period, and the first frequency point occupies the whole modulation period.

Performing frequency point resolving on the beat frequency signal of the one modulation period can be as follows: performing analog-to-digital conversion on the beat frequency signal to obtain a digital signal, performing fast Fourier transform on the digital signal to obtain a first frequency point and a second frequency point, and determining a target velocity measurement result and a target distance measurement result based on the first frequency point and the second frequency point.

In this embodiment, the first frequency point corresponds to the first modulated optical signal, and the second frequency point corresponds to the second modulated optical signal. Based on the first frequency point and the second frequency point, the target velocity measurement result and the target distance measurement result can be determined, the target velocity measurement result can include a moving velocity of the detected target and a velocity direction of the moving velocity of the detected target, and the target distance measurement result can be a distance between the light source and the detected target.

Within one modulation period, the optical switch is only turned on for a portion of the period. Here, the optical switch can be turned on within half of one modulation period. Since the second reference path optical signal passes through the optical switch, the second frequency point occupies half of the modulation period, and the first frequency point occupies the whole modulation period.

In an implementation, the target velocity measurement result can include the velocity direction of the moving velocity of the detected target, which is determined based on a relative relationship between the first frequency point and the second frequency point. For example, the velocity direction of the moving velocity of the detected target can be determined according to a comparison result obtained by comparing the magnitude relationship between the first frequency point and the second frequency point.

The information detection system can include a processing module, which is configured to perform frequency point resolving on the beat frequency signal of one modulation period to obtain the first frequency point and the second frequency point, and determine the target velocity measurement result and the target distance measurement result based on the first frequency point and the second frequency point. The step S808 can be performed by the processing module.

According to the embodiment provided by the present application, the first modulated optical signal and the second modulated optical signal are provided and divided by the light source, the first modulated optical signal is divided into the first measurement path optical signal and the first reference path optical signal, the second modulated optical signal is divided into the second measurement path optical signal and the second reference path optical signal, where the phase of the first modulated optical signal is opposite to that of the second modulated optical signal. The first measurement path optical signal and the second measurement path optical signal are combined into the detection path optical signal, the detection path optical signal is transmitted into the specified space to obtain the echo signal; the first reference path optical signal and the second reference path optical signal which passes through the optical switch are combined into the reference path optical signal, and frequency beating is performed on the echo signal with reference path optical signal which is used as a local oscillator signal, and the beat frequency signal is obtained; where within one modulation period, the optical switch is only turned on for a portion of the period; frequency point resolving is performed on the beat frequency signal of one modulation period to obtain the first frequency point and the second frequency point, and the target velocity measurement result and the target distance measurement result are determined based on the first frequency point and the second frequency point, where the first frequency point corresponds to the first modulated optical signal, the second frequency point corresponds to the second modulated optical signal, the second frequency point occupies half of the modulation period, and the first frequency point occupies the whole modulation period. In this way, the velocity direction can be determined based on a combined analysis of the on/off time of the switch and the order in which the frequency points appear, thereby solving the problem in related art that the velocity direction cannot be measured by using a single laser, as well as improving the accuracy of information detection.

As a solution, within one modulation period, the optical switch is turned on within a first time period and turned off within a second time period, performing frequency point resolving on the beat frequency signal of one modulation period to obtain the first frequency point and the second frequency point includes:
performing frequency point resolving on the beat frequency signal within the first time period of one modulation period to obtain the first frequency point and the second frequency point, and performing frequency point resolving on the beat frequency signal within the second time period of one modulation period to obtain the first frequency point.

In this embodiment, when the optical switch is turned on within the first time period, the reference path optical signal within the first time period is obtained by combining the first reference path optical signal and the second reference path optical signal, frequency beating is performed on the echo signal by using the reference path optical signal as a local oscillator signal, and frequency point resolving is performed based on the beat frequency signal to obtain the first frequency point and the second frequency point corresponding to the first modulated optical signal and the second modulated optical signal respectively. When the optical switch is turned off within the second time period, the reference path optical signal within the second time period is composed of the first reference path optical signal, frequency beating is performed on the echo signal by using the reference path optical signal as a local oscillator signal, and frequency point resolving is performed based on the beat frequency signal, only the first frequency point corresponding to the first modulated optical signal can be obtained.

The information detection system can include a processing module, which is configured to perform frequency point resolving on the beat frequency signal of one modulation period to obtain the first frequency point and the second frequency point, the solution in this embodiment can be performed by the processing module.

According to this embodiment, by controlling the on-off status of the optical switch in different time periods, different frequency points can be obtained based on frequency point resolving in different time periods, thereby allowing for determining the target velocity measurement result and the target distance measurement result.

As a solution, both the first modulated optical signal and the second modulated optical signal are triangular wave signals; within one modulation period, the optical switch is turned on within the first half of the one modulation period and turned off within the second half of the one modulation period; or, within one modulation period, the optical switch is turned off within the first half of the one modulation period and turned on within the second half of the one modulation period.

It should be noted that since there are two modulated optical signals, the first modulated optical signal and the second modulated optical signal are both triangular wave signals, and the phase of the first modulated optical signal is opposite to that of the second modulated optical signal.

In this embodiment, in a case where within one modulation period, the optical switch is turned on within the first half of the one modulation period and turned off within the second half of the one modulation period, the first frequency point and the second frequency point can be obtained by performing frequency point resolving on the beat frequency signal in the first half of the one modulation period, the first frequency point can be obtained by performing frequency point resolving on the beat frequency signal in the second half of the one modulation period. In a case where within one modulation period, the optical switch is turned off within the first half of the one modulation period and turned on within the second half of the one modulation period, the first frequency point can be obtained by performing frequency point resolving on the beat frequency signal in the first half of the one modulation period, the first frequency point and the second frequency point can be obtained by performing frequency point resolving on the beat frequency signal in the second half of the one modulation period.

According to this embodiment, the waveforms of the first modulated optical signal and the second modulated optical signal and the on-off (opening and closing) strategy of the optical switch are defined, which is beneficial for determining the first frequency point and the second frequency point.

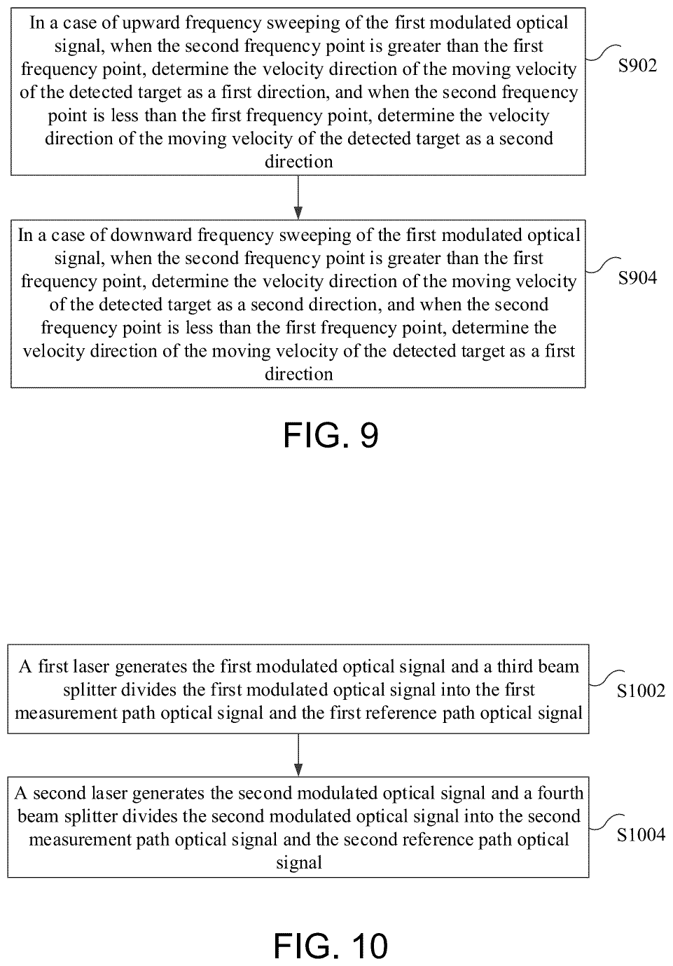

As a solution, refer to FIG. 9, which is a schematic flowchart of another information detection method provided by an embodiment of the present application. As shown in FIG. 9, determining the target velocity measurement result and the target distance measurement result based on the first frequency point and the second frequency point includes the following steps.

Step S902, in a case of upward frequency sweeping of the first modulated optical signal, when the second frequency point is greater than the first frequency point, determine the velocity direction of the moving velocity of the detected target as a first direction, and when the second frequency point is less than the first frequency point, determine the velocity direction of the moving velocity of the detected target as a second direction.

In this embodiment, frequency sweeping refers to a process in which the frequency of a signal changes continuously from high to low (or from low to high) within a frequency band; in the case of upward frequency sweeping of the first modulated optical signal means that in a process of the frequency of the first modulated optical signal changing from low to high, comparing the magnitude of the first frequency point with that of the second frequency point, and determining the moving velocity of the detected target based on a comparison result of the magnitudes of the first frequency point and the second frequency point; when the second frequency point is greater than the first frequency point, determining the velocity direction of the moving velocity of the detected target as the first direction, that is, determining the velocity direction of the moving velocity of the detected target to be the direction away from the light source; when the second frequency point is less than the first frequency point, determining the velocity direction of the moving velocity of the detected target as the second direction, that is, determining the velocity direction of the moving velocity of the detected target to be the direction towards the light source.

Step S904, in a case of downward frequency sweeping of the first modulated optical signal, when the second frequency point is greater than the first frequency point, determine the velocity direction of the moving velocity of the detected target as a second direction, and when the second frequency point is less than the first frequency point, determine the velocity direction of the moving velocity of the detected target as a first direction.

In this embodiment, in the case of downward frequency sweeping of the first modulated optical signal means that in a process of the frequency of the first modulated optical signal changing from high to low, comparing the magnitude of the first frequency point with that of the second frequency point, and determining the moving velocity of the detected target based on a comparison result of the magnitudes of the first frequency point and the second frequency point; when the second frequency point is greater than the first frequency point, determining the velocity direction of the moving velocity of the detected target as the second direction, that is, determining the velocity direction of the moving velocity of the detected target to be the direction towards the light source; when the second frequency point is less than the first frequency point, determining the velocity direction of the moving velocity of the detected target as the first direction, that is, determining the velocity direction of the moving velocity of the detected target to be the direction away from the light source. The light source can be the first light source or the second light source. In this embodiment, the first direction is a direction away from the first light source, and the second direction is a direction towards the first light source; or, the first direction is a direction away from the second light source, and the second direction is a direction towards the second light source.

The information detection system can include a processing module, which is configured to determine the velocity direction of the moving velocity of the detected target based on the first frequency point and the second frequency point, the steps in this embodiment can be performed by the processing module.

According to this embodiment, the velocity direction of the moving velocity of the detected target can be determined based on the first frequency point and the second frequency point, thus improving the accuracy of information detection.

As a solution, refer to FIG. 10, which is a schematic flowchart of yet another information detection method provided by an embodiment of the present application. In an implementation, a light source includes a first light source and a second light source, and the first light source is used to provide and divide the first modulated optical signal into the first measurement path optical signal and the first reference path optical signal, and the second light source is used to provide and divide the second modulated optical signal into the second measurement path optical signal and the second reference path optical signal. In general, as shown in FIG. 10, providing the first modulated optical signal and the second modulated optical signal by the light source, dividing the first modulated optical signal into the first measurement path optical signal and the first reference path optical signal, dividing the second modulated optical signal into the second measurement path optical signal and the second reference path optical signal include the followings.

Step S1002, the first laser generates the first modulated optical signal and a third beam splitter divides the first modulated optical signal into the first measurement path optical signal and the first reference path optical signal.

Step S1004, the second laser generates the second modulated optical signal and a fourth beam splitter divides the second modulated optical signal into the second measurement path optical signal and the second reference path optical signal.

In this embodiment, the first light source can include the first laser and the third beam splitter, the second light source can include the second laser and the fourth beam splitter; the first modulated optical signal is generated by the first laser, the first modulated optical signal is divided into the first measurement path optical signal and the first reference path optical signal by the third beam splitter; the second modulated optical signal is generated by the second laser, and the second modulated optical signal is divided into the second measurement path optical signal and the second reference path optical signal by the fourth beam splitter.

It should be noted that, in this embodiment, the beam splitter can be a 1×2 coupler, which is configured to split a specific input beam into two parallel output beams.

The information detection system can include the light source, and the steps of this embodiment can be performed by the light source. The light source can include the first laser, the second laser, the third beam splitter and the fourth beam splitter, that is, the steps of this embodiment can be jointly performed by the first laser, the second laser, the third beam splitter and the fourth beam splitter.

As a solution, combining the first measurement path optical signal and the second measurement path optical signal into the detection path optical signal includes:
S41, a fourth beam combiner combining the first measurement path optical signal and the second measurement path optical signal into the detection path optical signal.

In this embodiment, the transceiving module can include the fourth beam combiner, and the first measurement path optical signal and second measurement path optical signal are combined into the detection path optical signal by the fourth beam combiner, and the detection path optical signal is used to detect information of the detected target in the specified space.

Combining the first reference path optical signal and the second reference path optical signal which passes through the optical switch into the reference path optical signal includes:
S42, a fifth beam combiner combining the first reference path optical signal and the second reference path optical signal which passes through the optical switch into the reference path optical signal.

In this embodiment, the processing module can include the fifth beam combiner, and the first reference path optical signal and second reference path optical signal which passes through the optical switch are combined into the reference path optical signal by the fifth beam combiner, and the reference path optical signal is used as the local oscillator signal for frequency beating with the echo signal.

It should be noted that in this embodiment, both the fourth beam combiner and the fifth beam combiner can be 2×1 couplers, and the 2×1 couplers can couple two beams into one beam.

The information detection system can include a transceiving module and a processing module, where the transceiving module is configured to combine the first measurement path optical signal and the second measurement path optical signal into the detection path optical signal, and the processing module is configured to combine the first reference path optical signal and the second reference path optical signal which passes through the optical switch into the reference path optical signal. The steps of this embodiment can be jointly performed by the transceiving module and the processing module.

The transceiving module can include the fourth beam combiner, and the processing module can include the fifth beam combiner. The fourth beam combiner is configured to combine the first measurement path optical signal and the second measurement path optical signal into the detection path optical signal, and the fifth beam combiner is configured to combine the first reference path optical signal and the second reference path optical signal which passes through the optical switch into the reference path optical signal. The steps of this embodiment can be jointly performed by the fourth beam combiner and the fifth beam combiner.

As a solution, performing frequency beating on the echo signal with the reference path optical signal which is used as a local oscillator signal to obtain the beat frequency signal includes:
S51, a sixth beam combiner performing frequency beating on the echo signal by using the reference path optical signal as the local oscillator signal to obtain the beat frequency signal;
S52, providing the beat frequency signal to a balance detector, and obtaining the first frequency point and the second frequency point by the balance detector.

In this embodiment, the processing module can include the sixth beam combiner and the balance detector. The sixth beam combiner is configured to perform frequency beating on the echo signal by using the reference path optical signal as the local oscillator signal to obtain the beat frequency signal, and provide the beat frequency signal to the balance detector, and the first frequency point and the second frequency point are obtained by the balance detector.

The processing module can also include an ADC and a digital signal processor. Obtaining the first frequency point and the second frequency point by the balance detector can be as follows. The sixth beam combiner provides the beat frequency signal to the balance detector, the balance detector performs photoelectric conversion on the beat frequency signal to obtain an electrical signal, the ADC performs analog-to-digital conversion on the electrical signal to obtain a digital signal (to obtain the first frequency point and the second frequency point). The digital signal processor performs processing based on the digital signal to obtain the target velocity measurement result and the target distance measurement result.

The processing module can include the sixth beam combiner and the balance detector, the sixth beam combiner is configured to obtain the beat frequency signal based on the reference path optical signal and the echo signal, and the balance detector is configured to obtain the first frequency point and the second frequency point based on the beat frequency signal. The steps of this embodiment can be jointly performed by the sixth beam combiner and the balance detector.

According to this embodiment, the beat frequency signal is obtained by the sixth beam combiner, and the first frequency point and the second frequency point are obtained by the balance detector, so that the information detection efficiency of the information detection method can be improved.

As a solution, transmitting the detection path optical signal into the specified space and receiving the echo signal includes:
S61, inputting the detection path optical signal into a first port of a circulator, transmitting the detection path optical signal into the specified space by a collimator connected to a second port of the circulator, and receiving the echo signal by the collimator; or,
S62, inputting the detection path optical signal into a first port of a circulator, transmitting the detection path optical signal into the specified space by an optical phase array connected to a second port of the circulator, and receiving the echo signal by the optical phase array.

In this embodiment, the transceiving module can include the circulator and the collimator, the circulator is configured to output the detection path optical signal input through the first port of the circulator to the collimator through the second port of the circulator, the collimator is configured to transmit the detection path optical signal into the specified space and receive the echo signal. The transceiving module can also include the circulator and the optical phase array, the circulator is configured to output the detection path optical signal input through the first port of the circulator to the optical phase array through the second port of the circulator, the optical phase array is configured to transmit the detection path optical signal into the specified space and receive the echo signal. The circulator is same/similar to the circulator in the embodiment according to FIG. 3 and is not repeated here again.

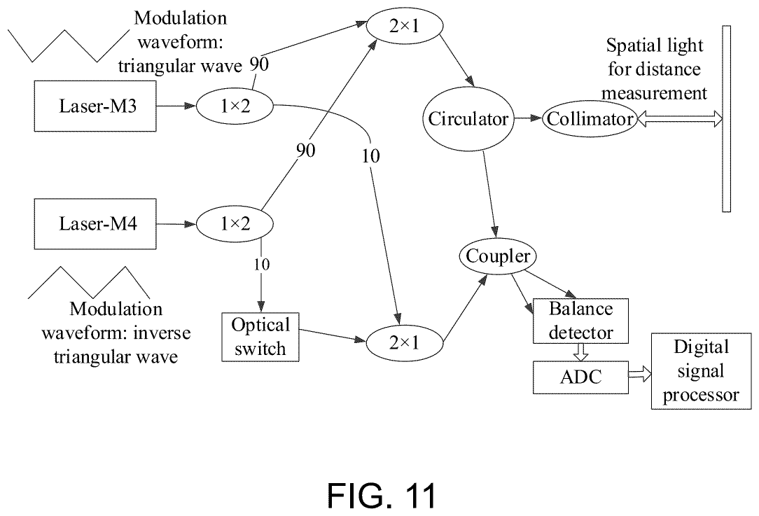

The information detection method in this embodiment is explained below with reference to examples. In this example, the information detection method can be performed by an information detection system, refer to FIG. 11, FIG. 11 a schematic structural diagram of an optional information detection system according to an embodiment of the present application. As shown in FIG. 11, the information detection system includes a laser M3, a laser M4, an optical switch, two 1×2 couplers, two 2×1 couplers, a circulator, a collimator, a 2×2 coupler, a balance detector, a ADC and a digital signal processor, and where:
the laser M3 is a distance measurement laser, laser M3 performs modulation with a high power, a long period and a wide bandwidth;
the laser M4 is a distance measurement laser, laser M4 serves as a secondary laser for performing reverse modulation with laser M3;
the optical switch is capable of achieving turn-off functions within microseconds;
the 1×2 coupler is configured to divide one laser beam into two laser beams;
the 2×1 coupler is configured to combine two laser beams into one laser beam.

In this embodiment, the information detection method includes the following. Laser M3 performs forward triangular wave modulation, laser M4 performs synchronous modulation using a triangular wave in reverse with the triangular wave used by laser M3. For laser M3, after modulation (with a triangular wave signal), a first modulated optical signal is generated, and the first modulated optical signal is divided into a first measurement path optical signal and a first reference path optical signal by a 1×2 coupler (which is a specific example of the third beam splitter above) (in practice, the optical power of the reference path is less than that of the measurement path, for example, the ratio of the optical power of the reference path to the optical power of the measurement path is 10:90). For laser M4, a second modulated optical signal is generated after the reverse triangular wave modulation, the second modulated optical signal is divided into a second measurement path optical signal and a second reference path optical signal by a 1×2 coupler (which is a specific example of the fourth beam splitter above) (in practice, the optical power of the reference path is less than that of the measurement path, for example, the ratio of the optical power of the reference path to the optical power of the measurement path is 10:90). Among them, an optical switch is connected in series in the reference path of the laser M4, and the opening and closing of the optical switch is controlled by a system master control.

Among them, the first measurement path optical signal and the second measurement path optical signal are combined into the detection path optical signal by the 2×1 coupler (which is a specific example of the fourth beam combiner above) and the detection path optical signal is input to port 1 of the circulator, and then output to the specified space through the collimator connected to port 2 of the circulator for distance measurement; after being reflected by the detected target, the signal is also received by the collimator and then passes through port 3 of the circulator to output the echo signal, and here, the detection path optical signal can also be input to the optical phase array for distance measurement.

The first reference path optical signal generated by laser M3 and the second reference path optical signal generated by laser M4 are combined into the reference path optical signal by the 2×1 coupler (which is a specific example of the fifth beam combiner above), the reference path optical signal and the echo signal are subject to frequency mixing and frequency beating by the 2×2 coupler (which is a specific example of the sixth beam combiner above) to obtain the beat frequency signal, the beat frequency signal is input into the balance detector and converted into an electrical signal, the electrical signal is input into the ADC and converted into a digital signal, and the ADC inputs the digital signal to the digital signal processor for processing.

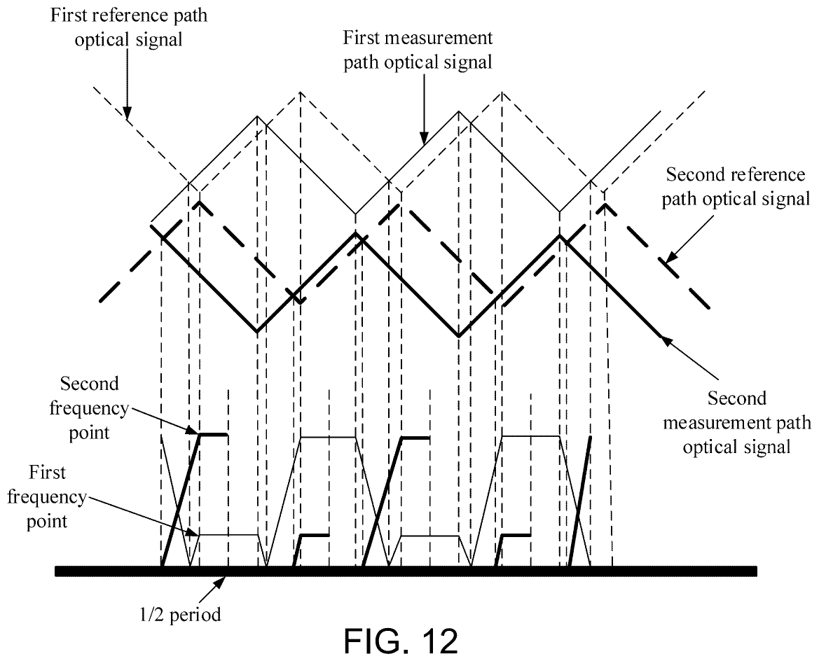

For the on-off strategy of the optical switch, refer to FIG. 12, which is a schematic diagram of an information detection method provided by an embodiment of the present application. As shown in FIG. 12, the optical switch is turned on within the first half period and turned off within the second half period, so that a back end can determine the velocity direction of the moving velocity of the detected target based on a combined analysis of segmented fast Fourier transform and whole segment fast Fourier transform, the on/off time of the switch and the order in which the frequency points appear.

The determination of the velocity and distance of this solution complies with the following flow.

It should be noted that since dual lasers are used for modulation, one half of the period of the modulated optical signal is one modulation period.

For the target velocity measurement result, in a case of upward frequency sweeping of the modulated signal, the optical switch is turned on within the first ½ period, and then two frequency points including the first frequency point and second frequency point can be obtained from fast Fourier transform for half period. The optical switch is turned off within the second ½ period, and only the first frequency point is available. According to the relationship between the first frequency point and the second frequency point, the velocity direction can be determined, if the second frequency point is greater than the first frequency point, the velocity direction is positive, if the second frequency point is less than the first frequency point, the velocity direction is negative. In a case of downward frequency sweeping of the modulated signal, if the second frequency point is greater than the first frequency point, the velocity direction is negative, if the second frequency point is less than the first frequency point, the velocity direction is positive. A formula for calculating the moving velocity of the detected target is shown in formula (2):

$$V = \frac{λ}{4} ( \vert {F}_{s 2} - {F}_{m 1} \vert ) \qquad ( 2 )$$

where λ is the central wavelength of the laser, Fₛ₂ represents the second frequency point, Fₘ₁ represents the first frequency point.

For the target distance measurement result, a formula for calculating the distance between the detected target and the laser is shown in Formula (3):

$$R = \frac{CT}{8 B} ( {F}_{s 2} + {F}_{m 1} ) \qquad ( 3 )$$

where C is the velocity of light, B is the modulation bandwidth, and T is the modulation period.

In addition, because laser M3 has the characteristics of high power, long period and wide modulation bandwidth, in each modulation period, sampling can be done for multiple times in the time period when the switch is on, thus improving the accuracy of information detection.

According to the embodiment of the present application, the lidar can scan and detect a target scanning area through laser signals (that is, the first optical signal and the second optical signal above), and determine parameters such as distance, azimuth, height, velocity, pose and even shape of the object in the target scanning area, so as to monitor the target scanning area, so it can be widely used in military, security, surveying, mapping and other fields. In recent years, with the rapid increase of intelligent devices such as autonomous driving devices, drones and robots, the demand for lidars is becoming more and more urgent, and the requirements for their performance are becoming stricter and stricter.

Lidars include TOF lidars based on time of fly (TOF) distance measurement technology and FMCW lidars based on frequency modulated continuous wave distance measurement technology. According to the TOF distance measurement technology, the distance of an obstacle is measured according to the time of fly of the laser. According to the FMCW distance measurement technology, the frequency of the laser is modulated to be linear using frequency modulation techniques (such as triangular wave frequency modulation or sawtooth wave frequency modulation), and a distance of an obstacle is determined according to a frequency difference between transmitted light and received light at the same time.

The measurement principle of FMCW lidar requires that instantaneous frequency of a laser signal is linear with time. Under normal circumstances, FMCW lidar determines the distance of the obstacle by effectively interfering with the frequency of the laser signal over a fixed modulation period. However, for close-range obstacles, the time required for effective interference in the FMCW lidar may be too long, thus reducing the ranging efficiency of the FMCW lidar; for distant obstacles, the time required for effective interference in the FMCW lidar may be too short, making it difficult to detect weak signals from long distances, thus reducing the ranging accuracy of the FMCW lidar.

In an implementation, when the first optical signal and the second optical signal in any of the above embodiments are laser signals transmitted by FMCW lidar, the transmission of the laser signal is controlled in such a way that it ensures the FMCW lidar's ranging efficiency for close obstacles while enhancing the ranging accuracy for distant obstacles.

It should be noted that sawtooth wave modulation is mainly used to measure the distance of obstacle, while triangular wave modulation can simultaneously obtain distance and velocity information of obstacle, since the sawtooth wave modulation only modulate the frequency of laser signal upwards in a modulation period; while the triangular wave modulation modulates the frequency of laser signal upwards and then downwards in a modulation period. The method for controlling transmission of a laser signal provided by the embodiment of the present application is mainly applied to FMCW lidar with triangular wave modulation.

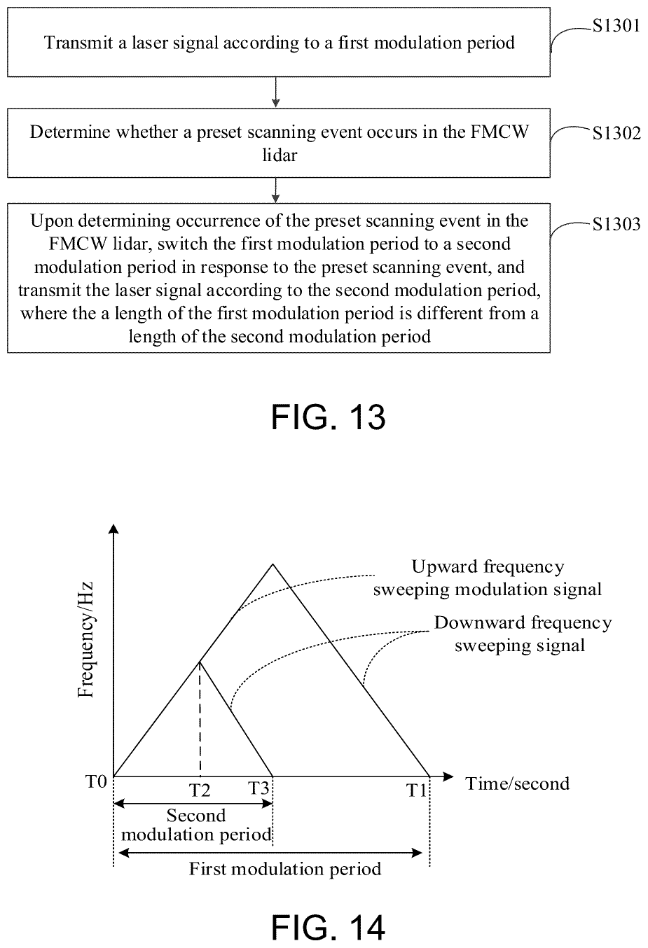

As shown in FIG. 13, which is a schematic flowchart of a method for controlling transmission of a laser signal provided by an embodiment of the present application, the method includes the following steps.

S1301, transmit a laser signal according to a first modulation period. The laser signal is a first optical signal or a second optical signal.

It can be understood that during the distance measurement process, FMCW lidar firstly modulates the laser signal according to a first modulation period, and transmits the laser signal to a detection space.

S1302, determine whether a preset scanning event occurs in the FMCW lidar.

It should be noted that the preset scanning event is related to a distance between an obstacle scanned by the FMCW lidar and the FMCW lidar.

S1303, upon determining occurrence of the preset scanning event in the FMCW lidar, switch the first modulation period to a second modulation period in response to the preset scanning event, and transmit the laser signal according to the second modulation period. A length of the first modulation period is different from a length of the second modulation period.

It can be understood that, in a process of transmitting the laser signal to the detection space according to the first modulation period, the FMCW lidar will detect a scanning event that occurs within itself, and when it is detected that the scanned event meets the preset scanning event, in response to the preset scanning event, the FMCW lidar switches from the first modulation period to the second modulation period.

According to the method for controlling transmission of a laser signal provided by the embodiment of the present application, because in the process of transmitting the laser signal according to the first modulation period, the FMCW lidar may detect the scanning event that occurs within itself, and respond to the preset scanning event in time when it is detected that the scanning event occurred meets the preset scanning event (that is, switch the first modulation period to the second modulation period, where a length of the first modulation period is different from a length of the second modulation period). Therefore, the FMCW lidar no longer modulates the laser signal using the fixed modulation period, so the FMCW lidar can balance the ranging efficiency and ranging accuracy in different scenarios.

In the following, the method for controlling transmission of a laser signal provided by the embodiment of the application will be described in detail in combination with different scanning events.

(1) Exemplary description is made with an example where the preset scanning event is a first scanning event.

It should be noted that the first modulation period of the FMCW lidar is the initial modulation period of the FMCW lidar. As shown in FIG. 14, a starting point of the first modulation period can be represented as TO and an ending point as T1. When the FMCW lidar transmits the laser signal according to the first modulation period, it transmits the upward frequency sweeping modulation signal of the triangular wave signal at time TO, and will not start transmitting the downward frequency sweeping modulation signal of the triangular wave signal until a whole segment of upward frequency sweeping modulation signal is transmitted, and finally completes one periodic modulation at time T1.

In this embodiment, the first scanning event can be as follows. In the i-th modulation period, the FMCW lidar detects at a first time in a process of an upward frequency sweeping modulation using a triangular wave signal, that an echo signal of the laser signal has been received.

It can be understood that i can be any positive integer, for example, i is 1, 3 or 5, which is not limited by the embodiments of the present application.

It should be noted that the first time is any time in the process of the FMCW lidar transmitting the upward frequency sweeping modulation signal. For example, the first time can be the 5th millisecond, 10th millisecond, 20th millisecond, etc., which is not limited by the embodiments of the present application.

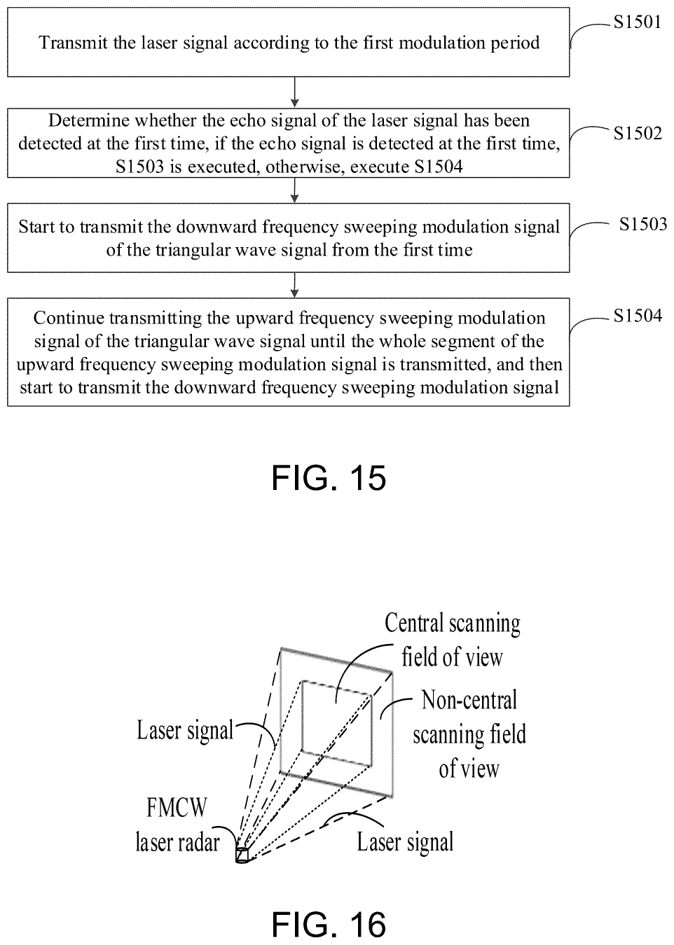

In this embodiment, a specific process of switching the first modulation period to the second modulation period in response to the first scanning event, as shown in FIG. 15, can include the following steps.

S1501, transmit the laser signal according to the first modulation period.

It should be noted that the related description of this step is the same as that in the above embodiment S1301, which is not repeated here again.

S1502, determine whether the echo signal of the laser signal has been detected at the first time, if the echo signal is detected at the first time, S1503 is executed, otherwise, execute S1504.

It should be noted that the FMCW lidar can continuously detect the echo signal of the laser signal after transmitting the upward frequency sweeping modulation signal.

S1503, start to transmit the downward frequency sweeping modulation signal of the triangular wave signal from the first time.

It can be understood that the first modulation period has been switched to the second modulation period at this time. The second modulation period is less than the first modulation period.

It should be noted that in this embodiment, a rate of frequency change of the upward frequency sweeping modulation signal is the same as a rate of frequency change of the downward frequency sweeping modulation signal. For example, as shown in FIG. 14, the first time is represented as T2. The length of the second modulation period is equal to twice the length of the time interval between T2 and TO, that is, the time at which T2 is located is in the center of the second modulation period. When the FMCW lidar detects at time T2 that it has received the echo signal of the laser signal, it will start to transmit the downward frequency sweeping modulation signal from time T2, so that the FMCW lidar completes one periodic modulation at time T3, that is, the FMCW lidar transmits the laser signal according to the second modulation period.

S1504, continue transmitting the upward frequency sweeping modulation signal of the triangular wave signal until the whole segment of the upward frequency sweeping modulation signal is transmitted, and then start to transmit the downward frequency sweeping modulation signal.

It can be understood that at this time, the FMCW lidar still transmits the laser signal according to the first modulation period.

For example, as shown in FIG. 14, when the FMCW lidar does not detect at time T2 that it has received the echo signal of the laser signal, it will continue transmitting the upward frequency sweeping modulation signal at time T2, and will not start to transmit the downward frequency sweeping modulation signal until the whole segment of the upward frequency sweeping modulation signal is transmitted, so that the FMCW lidar can complete one periodic modulation at time T1, that is, the FMCW lidar transmits the laser signal according to the first modulation period.

(2) Exemplary description is made with an example where a preset scanning event is a second scanning event.

It should be noted that the FMCW lidar usually scans based on a fixed scanning angle, so the scanning field of view formed when the FMCW lidar scans an obstacle can be divided into a central scanning field of view and a non-central scanning field of view (that is, an edge scanning field of view) according to the position of the obstacle.

Illustrative, as shown in FIG. 16, which is a schematic diagram of a scanning field of view formed by a FMCW lidar transmitting laser signal provided by an embodiment of the present application. As shown in FIG. 16, the field of view directly in front of the FMCW lidar can be called central scanning field of view, and the field of view that is not directly in front of the FMCW lidar can be called non-central scanning field of view.

Among them, obstacles in the central scanning field of view are located further directly in front of the FMCW lidar; however, in the non-central scanning field of view, the farthest obstacle area is usually the ground or wall, and distances between the obstacles located therein and the FMCW lidar are relatively close.

In this embodiment, the modulation period for processing the laser signal by the FMCW lidar can be controlled according to different scanning angular ranges. Therefore, the second scanning event can be: the scanning angle of the FMCW lidar being switched from a first angular range to a second angular range, and a modulation period of the laser signal corresponding to the first angular range being different from a modulation period of the laser signal corresponding to the second angular range.

Among them, the first angular range can be an angular range covering the non-central scanning field of view, or an angular range of the non-central scanning field of view. It can be understood that when the first angular range is the angular range covering the non-central scanning field of view, the second angular range is the angular range covering the central scanning field of view; or, when the first angular range is the angular range covering the central scanning field of view, the second angular range is the angular range covering the non-central scanning field of view. In this embodiment, the modulation period corresponding to the central scanning field of view is greater than the modulation period corresponding to the non-central scanning field of view.

It should be noted that whether the angular range scanned by the FMCW lidar covers the central scanning field of view can be determined by acquiring the range in the horizontal direction and the range in the vertical direction scanned by the FMCW lidar.

In this embodiment, in response to the second scanning event, a specific process of switching the first modulation period to the second modulation period can include two situations, specifically as follows.

Situation 1: when the first angular range covers the non-central scanning field of view and the second angular range covers the central scanning field of view, and it is detected that the scanning angle of the FMCW lidar is switched from the first angular range to the second angular range, switch the first modulation period to the second modulation period, in this case, the first modulation period is less than the second modulation period.

Situation 2: when the first angular range covers the central scanning field of view and the second angular range covers the non-central scanning field of view, and it is detected that the scanning angle of the FMCW lidar is switched from the first angular range to the second angular range, switch the first modulation period to the second modulation period, in this case, the first modulation period is greater than the second modulation period.

It can be understood that in this embodiment, among the first modulation period and the second modulation period, the modulation period with a larger period length is the initial modulation period of the FMCW lidar in the above embodiment of the present application, and a smaller modulation period length can be set according to the actual application, which is not limited by the present application.

(3) Exemplary description is made with an example where a preset scanning event is a third scanning event.

It should be noted that when the FMCW lidar scans an obstacle, the same modulation period can be used for the same obstacle because the object has continuity.

In this embodiment, the modulation period for processing the laser signal by the FMCW lidar can be controlled according to the distance between the obstacle and the FMCW lidar. Therefore, the third scanning event can be: in a process of transmitting the laser signal according to the first modulation period, the distance between the obstacle scanned in the i-th modulation period and the FMCW lidar is detected to meet a preset condition.

It can be understood that the description about i is the same as that in the above embodiment, which is not repeated here again.

Among them, the preset condition is: the distance between the obstacle and the FMCW lidar being less than a threshold; or, the distance between the obstacle and the FMCW lidar being greater than or equal to the threshold.

It should be noted that the threshold can be set according to the actual application, for example, it can be 5 meters, 8 meters or 20 meters, which is not limited by the embodiments of the present application.

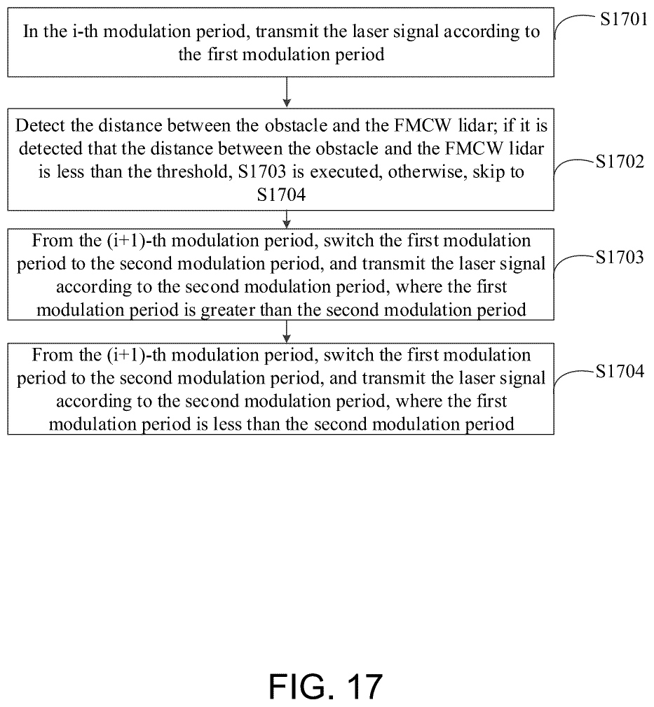

In this embodiment, a specific process of switching the first modulation period to the second modulation period in response to the third scanning event, as shown in FIG. 17, can include the following steps.

S1701, in the i-th modulation period, transmit the laser signal according to the first modulation period.

It should be noted that the related description of this step is the same as that in the above embodiment S1301, which is not repeated here again.

S1702: detect the distance between the obstacle and the FMCW lidar; if it is detected that the distance between the obstacle and the FMCW lidar is less than the threshold, S1703 is executed, otherwise, skip to S1704.

S1703: from the (i+1)-th modulation period, switch the first modulation period to the second modulation period, and transmit the laser signal according to the second modulation period, where the first modulation period is greater than the second modulation period.

S1704: from the (i+1)-th modulation period, switch the first modulation period to the second modulation period, and transmit the laser signal according to the second modulation period, where the first modulation period is less than the second modulation period.

It should be noted that in this embodiment, in the case where the first modulation period is greater than the second modulation period, if it is detected that the distance between the obstacle and the FMCW lidar is greater than or equal to the threshold, continue transmitting the laser signal according to the first modulation period in the (i+1)-th modulation period; in the case where the first modulation period is less than the second modulation period, if it is detected that the distance between the obstacle and the FMCW lidar is less than the threshold, continue transmitting the laser signal according to the first modulation period in the (i+1)-th modulation period.

For example, when the threshold is 5 meters and the first modulation period is greater than the second modulation period, the FMCW lidar transmits the laser signal according to the first modulation period in the 1st modulation period; if it is detected that the distance between the obstacle and the FMCW lidar is less than 5 meters, the FMCW lidar switches the first modulation period to the second modulation period in the 2nd modulation period; otherwise, it continues transmitting the laser signal according to the first modulation period in the 2nd modulation period.

Similarly, when the first modulation period is less than the second modulation period, the FMCW lidar transmits the laser signal according to the first modulation period in the 1st modulation period; if it is detected that the distance between the obstacle and the FMCW lidar is less than 5 meters, the FMCW lidar continues transmitting the laser signal according to the first modulation period in the 2nd modulation period; otherwise, it switches the first modulation period to the second modulation period in the 2nd modulation period.

It can be understood that in this embodiment, the first modulation period is the initial modulation period of the FMCW lidar.

To sum up, according to the method for controlling transmission of a laser signal provided by the embodiment of the present application, because in the process of transmitting the laser signal according to the first modulation period, the FMCW lidar may detect the scanning event that occurs within itself, and respond to the preset scanning event in time when it is detected that the scanning event occurred meets the preset scanning event (that is, switch the first modulation period to the second modulation period, where a length of the first modulation period is different from a length of the second modulation period). Therefore, the FMCW lidar no longer modulates the laser signal using the fixed modulation period, so the FMCW lidar can balance the ranging efficiency and ranging accuracy in different scenarios.

The FMCW lidar is exemplarily described below.

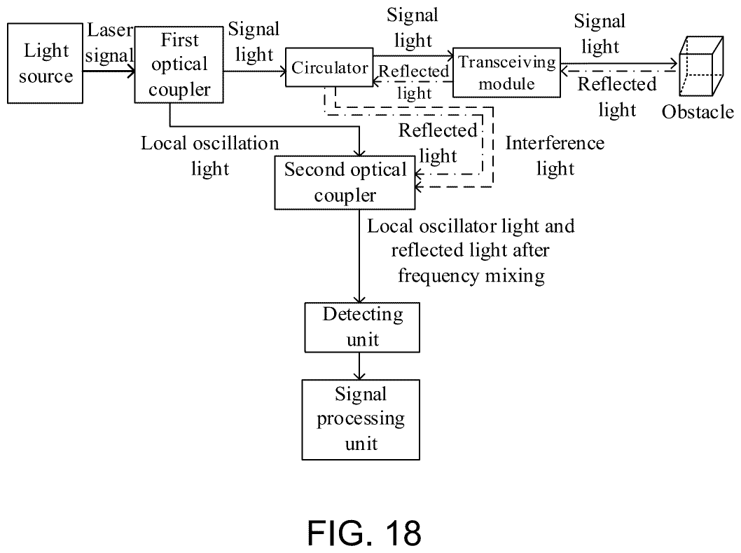

FIG. 18 is a schematic structural diagram of a FMCW lidar provided by an embodiment of the present application. Refer to FIG. 18, the FMCW lidar includes a light source, a first optical coupler, a circulator, a transceiving module, a second optical coupler, a detecting unit and a signal processing unit.

The light source is a frequency-modulated narrow-linewidth light source, which is configured to transmit a laser signal with a linewidth less than a preset linewidth (for example, 10 MHz), and the laser signal is subject to frequency modulation and the frequency after frequency modulation is linear.

The first optical coupler is configured to divide the laser signal into signal light and local oscillation light according to a preset ratio (for example, 1:9, 1:99, etc.). Because both signal light and local oscillator light are obtained by splitting the same laser signal, change rules of the frequencies of the signal light and the local oscillator light are the same, and the frequency after frequency modulation is linear.

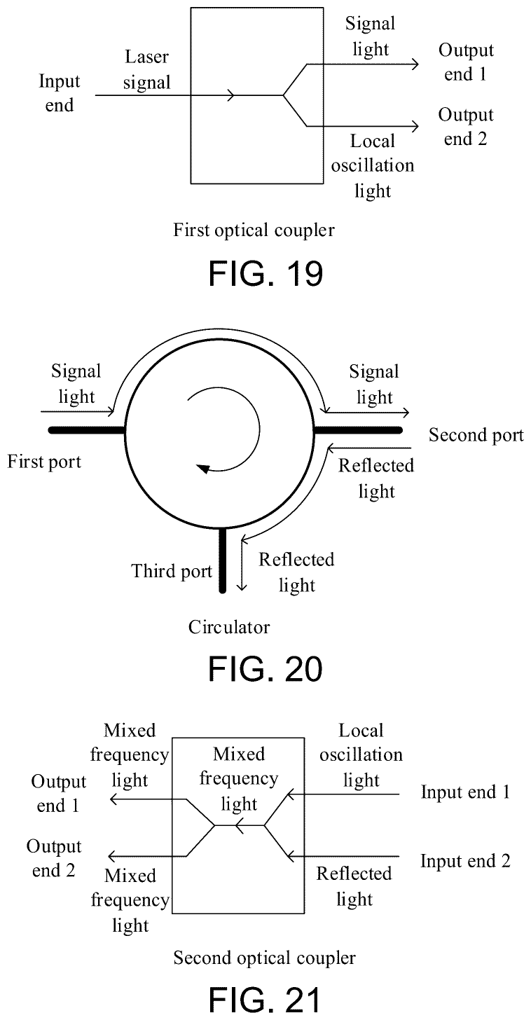

In an embodiment of the present application, as shown in FIG. 19, the first optical coupler is a 1×2 optical coupler, that is, the first optical coupler includes an input end and two output ends 1 and 2. The input end is connected to an output end of the light source, for receiving the laser signal. The output end 1 is connected to the circulator, for transmitting the received laser signal as signal light to the circulator; the output end 2 is connected to the second optical coupler, for transmitting the local oscillation light to the second optical coupler.

The circulator is configured to receive the signal light provided by the first optical coupler and provide it to the transceiving module; and receive reflected light provided by the transceiving module and transmit the reflected light to the second optical coupler for beam combining processing, where the reflected light is signal light reflected by the obstacle in the detection space. Illustratively, refer to FIG. 20, the circulator includes a first port, a second port and a third port. The first port is connected with the output end of light source, the second port is connected to the transceiving module, and the third port is connected to the second optical coupler. The circulator receives the signal light through the first port and transmits the signal light from the second port to the optical entrance and exit of the transceiving module. In addition, the circulator receives the reflected light through the second port from the transceiving module and sends it to the second optical coupler through the third port.

The transceiving module is configured to transmit the signal light to the obstacle and receive the reflected light returned after the signal light meets the obstacle. It should be noted that in the transceiving module, the outgoing path of the signal light and the incoming path of the reflected light are the same optical path, based on the principle reversibility of optical path.

In an embodiment of the present application, the transceiving module includes an optical lens group provided with one or more optical lenses, which can improve the efficiency of transmitting and receiving the optical signal by the transceiving module.

The second optical coupler is configured to perform frequency mixing on the reflected light and the local oscillator light, and send the mixed frequency light to the detecting unit. The second optical coupler may be a mixer, the local oscillation light mixes with the reflected light in the mixer to generate frequency-difference signal, and frequency-difference signal is the mixed frequency light. The second optical coupler also may be a combiner, and the local oscillation light beats with the reflected light in the combiner to generate beat frequency signal, and the beat frequency signal is the mixed frequency light.

In an embodiment of the present application, refer to FIG. 21, the second optical coupler is a 2×2 optical coupler, that is, the second optical coupler includes two input ends: input end 1 and input end 2, and two output ends: output end 1 and output end 2. The input end 1 is connected to the exit end 2 of the first optical coupler, for inputting the local oscillation light; the input end 2 is connected to the third port of the circulator, for inputting reflected light; both output ends are connected to different input ends of the detecting unit.

The detecting unit is configured to convert the mixed frequency light into an electrical signal. The mixed frequency light includes the local oscillation light and the reflected light, and the frequencies of the local oscillation light and the reflected light are different.

In an embodiment of the present application, the detecting unit is a balance detector, that is, the detector has two input ends for the mixed frequency light. The balance detecting unit is used in cooperation with the 2×2 second optical coupler to receive the dual channel mixed frequency light output by the second optical coupler.

The signal processing unit can be a circuit module with logic operation capabilities such as a single chip microcomputer, a digital signal processor (DSP) or a field-programmable gate array (FPGA). The signal processing unit is configured to determine relevant information of the obstacle according to the electric signal sent by the detecting unit. The related information of the obstacle includes at least one of distance information, velocity information, azimuth information, height information, pose information and shape information.

It should be noted that for the sake of simple description, all the aforementioned method embodiments are described as a combination of a series of actions, but those skilled in the art should know that the present application is not limited by the sequence of actions described, because some steps can be performed in other sequences or at the same time according to the present application. Secondly, those skilled in the art should also know that the embodiments described in the specification are all preferred embodiments, and the actions and modules involved are not necessarily mandatory for the present application.

Through the description of the above embodiments, those skilled in the art can clearly understand that the methods according to the above embodiments can be implemented by means of software plus a necessary general hardware platform, and certainly can also be implemented by hardware, but in many cases, the former is a better implementation. Based on this understanding, the essence of the technical solution of the embodiment of the present application or the part that contributes to the prior art can be reflected in the form of a software product, the computer software product is stored in a storage medium (such as ROM/RAM, magnetic disk, optical disk) and includes several instructions to make a terminal device (which can be a mobile phone, a computer, a server, or a network device, etc.) execute the methods of various embodiments of the present application.

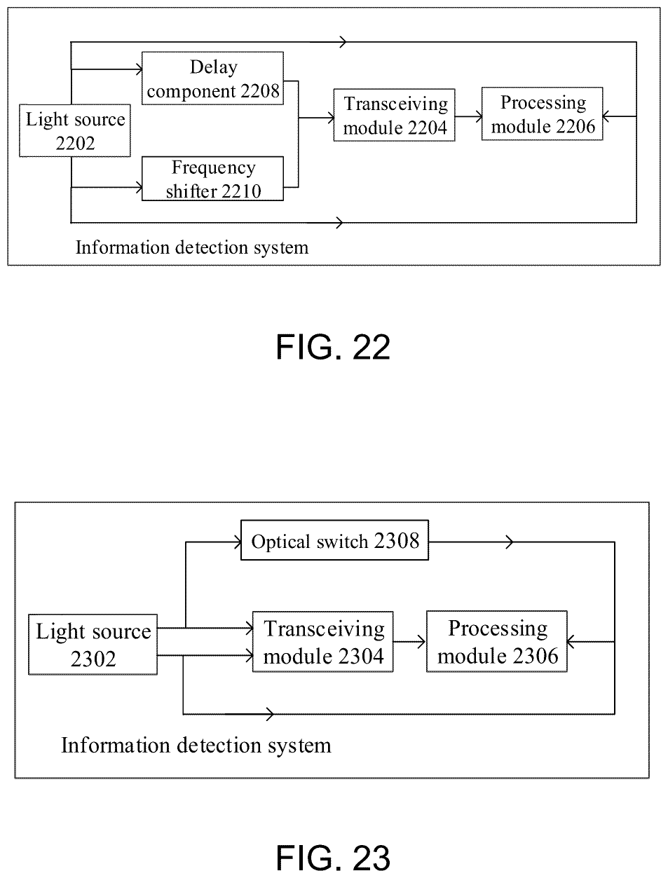

According to another aspect of embodiments of the present application, an information detection system is also provided, which is used to implement the information detection method provided in the above embodiments, which has already been explained and will not be repeated. Refer to FIG. 22, FIG. 22 is a structural diagram of an information detection system according to an embodiment of the present application. As shown in FIG. 22, the information detection system can include: a light source 2202 (the first light source and the second light source are both included here), a transceiving module 2204, and a processing module 2206, a delay component 2208, a frequency shifter 2210.

The light source 2202 is configured to generate a distance measurement beam and a velocity measurement beam, divide the distance measurement beam into a first distance measurement optical signal and a second distance measurement optical signal, and divide the velocity measurement beam into a first velocity measurement optical signal and a second velocity measurement optical signal. In an implementation, the first light source generates and divides the distance measurement beam into the first distance measurement optical signal and the second distance measurement optical signal; the second light source generates and divides the velocity measurement beam into the first velocity measurement optical signal and the second velocity measurement optical signal.

The delay component 2208 is configured to perform delay processing on the first distance measurement optical signal to obtain the delayed first distance measurement optical signal.

The frequency shifter 2210 is configured to shift a frequency of the first velocity measurement optical signal by a specified frequency offset to obtain the frequency-shifted first velocity measurement optical signal.

The transceiving module 2204 is configured to combine the delayed first distance measurement optical signal and the frequency-shifted first velocity measurement optical signal into a detection optical signal, transmit the detection optical signal into a detection space, and receive an echo signal.

The processing module 2206 is configured to combine the second distance measurement optical signal and the second velocity measurement optical signal into a reference optical signal, and perform frequency beating on the reference optical signal and the echo signal to obtain a beat frequency signal; determine velocity information based on a velocity measurement frequency point located in a velocity frequency interval among two frequency points resolved from the beat frequency signal, and determine distance information based on a distance measurement frequency point located in a distance frequency interval among the two frequency points, where the velocity frequency interval is symmetrical with respect to a frequency point for the specified frequency, and the velocity frequency interval and the distance frequency interval do not overlap.

According to the above information detection system, the distance measurement beam and the velocity measurement beam are generated by the light source, the distance measurement beam is divided into the first distance measurement optical signal and the second distance measurement optical signal, and the velocity measurement beam is divided into the first velocity measurement optical signal and the second velocity measurement optical signal; delay processing is performed on the first distance measurement optical signal to obtain the delayed first distance measurement optical signal, and a frequency of the first velocity measurement optical signal is shifted by the specified frequency offset to obtain the frequency-shifted first velocity measurement optical signal; the delayed first distance measurement optical signal and the frequency-shifted first velocity measurement optical signal are combined into the detection optical signal, the detection optical signal is transmitted into the detection space and the echo signal is received; the second distance measurement optical signal and the second velocity measurement optical signal are combined into the reference optical signal, and frequency beating is performed on the reference optical signal and the echo signal to obtain the beat frequency signal; the velocity information is determined based on the velocity measurement frequency point located in the velocity frequency interval among the two frequency points resolved from the beat frequency signal, and the distance information is determined based on the distance measurement frequency point located in the distance frequency interval among the two frequency points, where the velocity frequency interval is symmetrical with respect to the frequency point for the specified frequency offset, and the velocity frequency interval and the distance frequency interval do not overlap; and then the velocity information can be determined based on the velocity measurement frequency point located in the velocity frequency interval, and the distance information can be determined based on the distance measurement frequency point located in the distance frequency interval among the two frequency points, and the velocity direction is determined according to a magnitude relationship between the velocity frequency point and the specified frequency offset, so only a single processing system (i.e., a single back-end solution system, usually including a balance detector, a single ADC and a single digital signal processor) is needed to resolve the distance, the velocity and the direction, and then the problem in related art that the velocity direction cannot be measured by using a single laser can be solved.

As a solution, the delay component comprises a delay optical fiber, the lowest frequency point of the delayed first distance measurement optical signal is greater than twice the specified frequency offset.

As a solution, the light source includes a distance measurement laser, a velocity measurement laser, a first beam splitter and a second beam splitter, where the distance measurement laser is configured to generate the distance measurement beam, the first beam splitter is configured to divide the distance measurement beam into the first distance measurement optical signal and the second distance measurement optical signal, the velocity measurement laser is configured to generate the velocity measurement beam; the second beam splitter is configured to divide the velocity measurement beam into the first velocity measurement optical signal and the second velocity measurement optical signal.

As a solution, the processing module can include a first beam combiner configured to combine the second distance measurement optical signal and the second velocity measurement optical signal into the reference optical signal; a second beam combiner configured to combine the reference optical signal and the echo signal to perform frequency beating on the reference optical signal and the echo signal in the second beam combiner to obtain the beat frequency signal, where the beat frequency signal is provided to a balance detector by the second beam combiner; the balance detector and an analog-to-digital converter are configured to perform photoelectric conversion and analog-to-digital conversion on the beat frequency signal in turn to obtain the velocity measurement frequency point and the distance measurement frequency point.

As a solution, the transceiving module includes a third beam combiner, configured to combine the delayed first distance measurement optical signal and the frequency-shifted first velocity measurement optical signal into the detection optical signal, and input the detection optical signal to a first port of a circulator; the circulator, configured to output the detection optical signal input through the first port to a collimator through a second port of the circulator; the collimator is configured to transmit the detection optical signal into the detection space and receive the echo signal; or, the circulator is configured to output the detection optical signal input through the first port to an optical phase array through a second port of the circulator; the optical phase array is configured to transmit the detection optical signal into the detection space and receive the echo signal.

According to another aspect of embodiments of the present application, an information detection system is also provided, which is used to implement the information detection method provided in the above embodiments, which has already been explained and will not be repeated. Refer to FIG. 23, FIG. 23 is a structural diagram of an optional information detection system according to an embodiment of the present application. As shown in FIG. 23, the information detection system can include: a light source 2302, a transceiving module 2304, and a processing module 2306 and an optical switch 2308.

The light source 2302 is configured to provide a first modulated optical signal and a second modulated optical signal, where the first modulated optical signal includes a first measurement path optical signal and a first reference path optical signal, the second modulated optical signal includes a second measurement path optical signal and a second reference path optical signal, the phase of the first modulated optical signal is opposite to that of the second modulated optical signal.

The transceiving module 2304 is configured to combine the first measurement path optical signal and the second measurement path optical signal into a detection path optical signal, transmit the detection path optical signal into a specified space and receive an echo signal.

The processing module 2306 is configured to combine the first reference path optical signal and the second reference path optical signal which passes through the optical switch 2308 into a reference path optical signal, and perform frequency beating on the echo signal by using the reference path optical signal as a local oscillator signal to obtain a beat frequency signal, where within one modulation period, the optical switch 2308 is only turned on for a portion of the period; perform frequency point resolving on the beat frequency signal of one modulation period to obtain a first frequency point and a second frequency point, and determine a target velocity measurement result and a target distance measurement result based on the first frequency point and the second frequency point, where the first frequency point corresponds to the first modulated optical signal, the second frequency point corresponds to the second modulated optical signal, the second frequency point occupies half of the modulation period, and the first frequency point occupies the whole modulation period.

According to the above information detection system, the first modulated optical signal and the second modulated optical signal are provided by the light source, the first modulated optical signal is divided into the first measurement path optical signal and the first reference path optical signal, the second modulated optical signal is divided into the second measurement path optical signal and the second reference path optical signal, where the phase of the first modulated optical signal is opposite to that of the second modulated optical signal; the first measurement path optical signal and the second measurement path optical signal are combined into the detection path optical signal, the detection path optical signal is transmitted into the specified space to obtain the echo signal; the first reference path optical signal and the second reference path optical signal which passes through the optical switch are combined into the reference path optical signal, and frequency beating is performed on the echo signal by using the reference path optical signal as a local oscillator signal to obtain the beat frequency signal, where within one modulation period, the optical switch is only turned on for a portion of the period; frequency point resolving is performed on the beat frequency signal of one modulation period to obtain the first frequency point and the second frequency point, and the target velocity measurement result and the target distance measurement result are determined based on the first frequency point and the second frequency point, where the first frequency point corresponds to the first modulated optical signal, the second frequency point corresponds to the second modulated optical signal, the second frequency point occupies half of the modulation period, and the first frequency point occupies the whole modulation period. In this way, the velocity direction can be determined based on a combined analysis of the on/off time of the switch and the order in which the frequency points appear, thereby solving the problem in related art that the velocity direction cannot be measured by using a single laser, as well as improving the accuracy of information detection.

As a solution, within one modulation period, the optical switch is turned on within a first time period and turned off within a second time period, the processing module is further configured to perform frequency point resolving on the beat frequency signal within the first time period of one modulation period to obtain the first frequency point and the second frequency point, and perform frequency point resolving on the beat frequency signal within the second time period of one modulation period to obtain the first frequency point.

As a solution, both the first modulated optical signal and the second modulated optical signal are triangular wave signals; within one modulation period, the optical switch is turned on within the first half of the one modulation period and turned off within the second half of the one modulation period; or, within one modulation period, the optical switch is turned off within the first half of the one modulation period and turned on within the second half of the one modulation period.

As a solution, the processing module is further configured to: in a case of upward frequency sweeping of the first modulated optical signal, when the second frequency point is greater than the first frequency point, determine the velocity direction of the moving velocity of the detected target as a first direction, and when the second frequency point is less than the first frequency point, determine the velocity direction of the moving velocity of the detected target as a second direction; in a case of downward frequency sweeping of the first modulated optical signal, when the second frequency point is greater than the first frequency point, determine the velocity direction of the moving velocity of the detected target as a second direction, and when the second frequency point is less than the first frequency point, determine the velocity direction of the moving velocity of the detected target as a first direction; where the first direction is a direction away from the light source, and the second direction is a direction towards the light source. In this embodiment, the first direction is a direction away from the first light source, and the second direction is a direction towards the first light source; or, the first direction is a direction away from the second light source, and the second direction is a direction towards the second light source.

As a solution, the light source further includes a first laser and a second laser, a third beam splitter and a fourth beam splitter, where the first laser is configured to generate the first modulated optical signal; the third beam splitter is configured to divide the first modulated optical signal into the first measurement path optical signal and the first reference path optical signal; the second laser is configured to generate the second modulated optical signal; the fourth beam splitter is configured to divide the second modulated optical signal into the second measurement path optical signal and the second reference path optical signal.

As a solution, the transceiving module includes a fourth beam combiner, the processing module includes a fifth beam combiner, where the fourth beam combiner is configured to combine the first measurement path optical signal and the second measurement path optical signal into a detection path optical signal; the fifth beam combiner is configured to combine the first reference path optical signal and the second reference path optical signal which passes through the optical switch into the reference path optical signal.

As a solution, the processing module includes a sixth beam combiner, configured to perform frequency beating on the echo signal by using the reference path optical signal as a local oscillator signal to obtain the beat frequency signal, and provide the beat frequency signal to a balance detector; and the balance detector is configured to determine the first frequency point and the second frequency point based on the beat frequency signal.

As a solution, the transceiving module includes a circulator and a collimator, where the circulator is configured to output the detection path optical signal input through a first port of the circulator to the collimator through a second port of the circulator, the collimator is configured to transmit the detection path optical signal into the specified space and receive the echo signal. Or, the transceiving module can also include a circulator and an optical phase array, where the circulator is configured to output the detection path optical signal input through a first port of the circulator to the optical phase array through a second port of the circulator, the optical phase array is configured to transmit the detection path optical signal into the specified space and receive the echo signal.

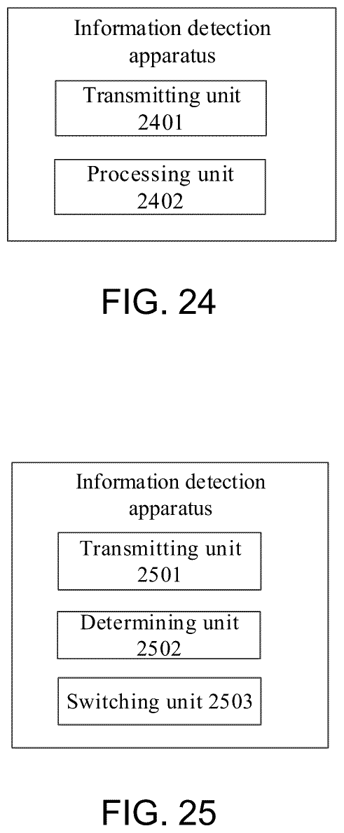

FIG. 24 is a structural schematic diagram of an information detection apparatus provided by an embodiment of the present application. As shown in FIG. 24, the information detection apparatus provided by this embodiment includes: a transmitting unit 2401 and a processing unit 2402.

The transmitting unit 2401 is configured to transmit a first optical signal and a second optical signal, divide the first optical signal into a first measurement optical signal and a first reference optical signal, and divide the second optical signal into a second measurement optical signal and a second reference optical signal.

The processing unit 2402 is configured to perform first processing on the first measurement optical signal and the second measurement optical signal to obtain a detection optical signal, transmit the detection optical signal into a detection space, and receive an echo signal.

The processing unit 2402 is further configured to perform second processing on the first reference optical signal and the second reference optical signal to obtain a reference optical signal, perform frequency beating on the reference optical signal and the echo signal to obtain a beat frequency signal; perform frequency point resolving on the beat frequency signal to obtain a first frequency point and a second frequency point, and determine velocity information and distance information of a detected target based on the first frequency point and the second frequency point.

The information detection apparatus provided by the embodiment of the present application can be used as the execution subject of the information detection method shown in FIG. 1. For example, in the information detection method shown in FIG. 1, step S104 can be executed by the transmitting unit 2401 in the information detection apparatus shown in FIG. 24, and steps S102 and 106 can be executed by the processing unit 2402 in the information detection apparatus shown in FIG. 24.

FIG. 25 is a structural schematic diagram of an apparatus for controlling transmission of a laser signal provided by an embodiment of the present application. As shown in FIG. 25, the apparatus for controlling transmission of a laser signal provided by this embodiment includes: a transmitting unit 2501, a determining unit 2502, and a switching unit 2503.

The transmitting unit 2501 is configured to transmit a laser signal according to a first modulation period.

The determining unit 2502 is configured to determine whether a preset scanning event occurs in the FMCW lidar.

The switching unit 2503 is configured to, upon determining occurrence of the preset scanning event in the FMCW lidar, switch the first modulation period to a second modulation period in response to the preset scanning event, and transmit the laser signal according to the second modulation period; where the a length of the first modulation period is different from a length of the second modulation period.

Based on the same inventive concept, an embodiment of the present application also provides an FMCW lidar configured to perform the method for controlling transmission of a laser signal in the above method embodiments.

The FMCW lidar provided by this embodiment can perform the above method embodiments, and its implementation principle and the technical effect are similar those of the method embodiments, which are not repeated here again.

According to yet another aspect of embodiments of the present application, a computer-readable storage medium is also provided, which includes a stored program, where when the program is run, the steps in any of the above method embodiments are executed.

In an exemplary embodiment, the above computer-readable storage medium may include, but is not limited to, a USB flash disk, a read-only memory (ROM), a random access memory (RAM), a removable hard disk, a magnetic disk or an optical disk and other mediums that can store computer programs.

According to yet another aspect of embodiments of the present application, an electronic device is also provided, which includes a memory and a processor, where a computer program is stored in the memory, and the processor is configured to execute the steps in any of the above method embodiments through the computer program.

In an exemplary embodiment, the above electronic device can further include a transmission device and an input/output device, where the transmission device is connected with the processor and the input/output device is connected with the processor.

For specific examples in this embodiment, reference can be made to the examples described in the above-mentioned embodiments and exemplary implementations, and this embodiment is not repeated here again.

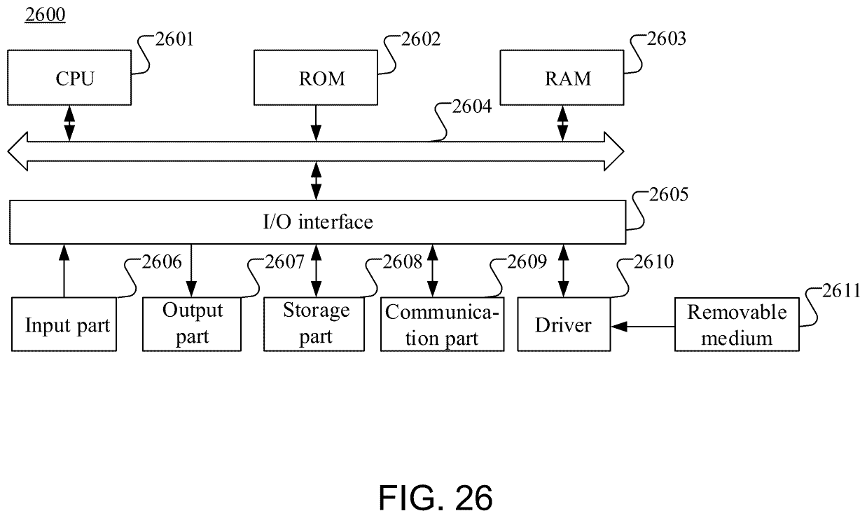

According to yet another aspect of embodiments of the present application, a computer program product is provided, which includes computer programs/instructions containing program codes for executing the method shown in the flowchart. In such embodiment, refer to FIG. 26, the computer program can be downloaded and installed from the network through a communication part 2609, and/or installed from a removable medium 2611. When the computer program is executed by a central processor 2601, various functions provided by the embodiments of the present application are executed. The above serial numbers of the embodiments of the present application are only for description, and do not represent the advantages and disadvantages of the embodiments.

Refer to FIG. 26, which is a structural block diagram of a computer system of an electronic device according to an embodiment of the present application.

FIG. 26 illustratively shows a block diagram of a computer system for implementing the electronic device of the embodiment of the present application. As shown in FIG. 26, a computer system 2600 includes a central processing unit (CPU), which can perform various appropriate actions and processes according to a program stored in a read-only memory 2602 or a program loaded from a storage part 2608 into a random access memory 2603. In the random access memory 2603, various programs and data required for system operation are also stored. The central processor 2601, the read-only memory 2602 and the random access memory 2603 are connected to each other through a bus 2604. An input/output interface 2605 (i.e., I/O interface) is also connected to the bus 8026.

The following components are connected to the input/output interface 2605: an input part 2606 including a keyboard, a mouse, etc.; an output part 2607 including, for example, a cathode ray tube (CRT), a liquid crystal display (LCD), etc., as well as a speaker, etc.; a storage part 2608 including a hard disk, etc.; and a communication part 2609 including a network interface card such as a local area network card, a modem, etc. The communication part 2609 performs communication processing via a network such as the Internet. A driver 2610 is also connected to the input/output interface 2605 as needed. A removable medium 2611, such as a magnetic disk, an optical disk, a magneto-optical disk, a semiconductor memory, etc., is installed on the drive 2610 as needed, so that a computer program read from it can be installed into the storage part 2608 as needed.

In particular, according to the embodiments of the present application, the processes described in flowcharts of the various methods can be implemented as computer software programs. For example, an embodiment of the present application includes a computer program product, which includes a computer program carried on a computer-readable medium, and the computer program contains program codes for executing the methods shown in the flowcharts. In such embodiment, the computer program can be downloaded and installed from the network through the communication part 2609 and/or installed from the removable medium 2611. When the computer program is executed by the central processor 2601, various functions defined in the system of the present application are performed.

It should be noted that the computer system 2600 of the electronic device shown in FIG. 26 is only an example, and should not bring any restrictions on the functions and application scope of the embodiments of the present application.

Embodiments of the present application can also be described using the following clauses.

1. A information detection method, including:
providing a first modulated optical signal and a second modulated optical signal by a light source, dividing the first modulated optical signal into a first measurement path optical signal and a first reference path optical signal, and dividing the second modulated optical signal into a second measurement path optical signal and a second reference path optical signal, where a phase of the first modulated optical signal is opposite to a phase of the second modulated optical signal;
combining the first measurement path optical signal and the second measurement path optical signal into a detection path optical signal, transmitting the detection path optical signal into a specified space and receive an echo signal;
combining the first reference path optical signal and the second reference path optical signal which passes through an optical switch into a reference path optical signal, and performing frequency beating on the echo signal by using the reference path optical signal as a local oscillator signal to obtain a beat frequency signal, where within one modulation period, the optical switch is only turned on for a portion of the period;
performing frequency point resolving on the beat frequency signal of one modulation period to obtain a first frequency point and a second frequency point, and determining a target velocity measurement result and a target distance measurement result based on the first frequency point and the second frequency point, where the first frequency point corresponds to the first modulated optical signal, the second frequency point corresponds to the second modulated optical signal, the second frequency point occupies half of the modulation period, and the first frequency point occupies the whole modulation period.

2. The method according to clause 1, where within one modulation period, the optical switch is turned on within a first time period and turned off within a second time period, performing frequency point resolving on the beat frequency signal of one modulation period to obtain the first frequency point and the second frequency point includes:
performing frequency point resolving on the beat frequency signal within the first time period of one modulation period to obtain the first frequency point and the second frequency point, and performing frequency point resolving on the beat frequency signal within the second time period of one modulation period to obtain the first frequency point.

3. The method according to clause 2, where both the first modulated optical signal and the second modulated optical signal are triangular wave signals;
within one modulation period, the optical switch is turned on within a first half of the one modulation period and turned off within a second half of the one modulation period; or, within one modulation period, the optical switch is turned off within a first half of the modulation period and turned on within a second half of the modulation period.

4. The method according to clause 2 or 3, where determining the target velocity measurement result and the target distance measurement result based on the first frequency point and the second frequency point includes:
in a case of upward frequency sweeping of the first modulated optical signal, when the second frequency point is greater than the first frequency point, determining the velocity direction of the moving velocity of the detected target as a first direction, and when the second frequency point is less than the first frequency point, determining the velocity direction of the moving velocity of the detected target as a second direction;
in a case of downward frequency sweeping of the first modulated optical signal is in a case of downward frequency sweeping, when the second frequency point is greater than the first frequency point, determining the velocity direction of the moving velocity of the detected target as a second direction, and when the second frequency point is less than the first frequency point, determining the velocity direction of the moving velocity of the detected target as a first direction;
where the first direction is a direction away from the light source, and the second direction is a direction towards the light source.

5. The method according to clause 1, where providing the first modulated optical signal and the second modulated optical signal by the light source, dividing the first modulated optical signal into the first measurement path optical signal and the first reference path optical signal, dividing the second modulated optical signal into the second measurement path optical signal and the second reference path optical signal includes:
generating the first modulated optical signal by a first laser and dividing the first modulated optical signal into the first measurement path optical signal and the first reference path optical signal by a third beam splitter;
generating the second modulated optical signal by a second laser and dividing the second modulated optical signal into the second measurement path optical signal and the second reference path optical signal by a fourth beam splitter.

6. The method according to clause 1, where
combining the first measurement path optical signal and the second measurement path optical signal into the detection path optical signal includes: combining the first measurement path optical signal and the second measurement path optical signal into the detection path optical signal by a fourth beam combiner;
combining the first reference path optical signal and the second reference path optical signal which passes through the optical switch into the reference path optical signal includes: combining the first reference path optical signal and the second reference path optical signal which passes through the optical switch into the reference path optical signal by a fifth beam combiner.

7. The method according to clause 1, where performing frequency beating on the echo signal by using the reference path optical signal as a local oscillator signal to obtain the beat frequency signal includes:
performing frequency beating on the echo signal by using the reference path optical signal as a local oscillator signal by a sixth beam combiner to obtain the beat frequency signal;
providing the beat frequency signal to a balance detector, and obtaining the first frequency point and the second frequency point by the balance detector.

8. The method according to clause 1, where transmitting the detection path optical signal into the specified space and receiving the echo signal includes:
inputting the detection path optical signal into a first port of a circulator, transmitting the detection path optical signal into the specified space by a collimator connected to a second port of the circulator, and receiving the echo signal by the collimator; or,
inputting the detection path optical signal into a first port of a circulator, transmitting the detection path optical signal into the specified space by an optical phase array connected to a second port of the circulator, and receiving the echo signal by the optical phase array.

Obviously, it should be understood by those skilled in the art that the various modules or various steps of the above embodiments of the present application can be implemented by general computing apparatuses, which can be centralized on a single computing apparatus or distributed on a network composed of multiple computing apparatuses, and can be implemented by program codes executable by computing apparatuses, so that they can be stored in storage apparatuses and executed by computing apparatuses, and in some cases, the steps shown or described may be performed in a different order from that described herein, or may be made into individual integrated circuit modules, or a plurality of modules or steps of them are made into a single integrated circuit module. In this way, the embodiments of the present application are not limited to any specific combination of hardware and software.

The above description is only the preferred embodiments of the present application, and is not intended to limit the embodiments of the present application. For those skilled in the art, the embodiments of the present application may have various modifications and changes. Any modification, equivalent replacement, or improvement made or the like within the principle of the embodiments of the present application shall fall within the protection scope of the embodiments of the present application.

What is claimed is:

1. An information detection method, comprising:
generating, a first optical signal by a first light source and a second optical signal by a second light source; dividing, the first optical signal into a first measurement optical signal and a first reference optical signal by the first light source, and dividing, the second optical signal into a second measurement optical signal and a second reference optical signal by the second light source;
performing delay processing on the first measurement optical signal to obtain a delayed first measurement optical signal, and shifting a frequency of the second measurement optical signal by a specified frequency offset to obtain a frequency-shifted second measurement optical signal;
combining the delayed first measurement optical signal and the frequency-shifted second measurement optical signal into a detection optical signal, transmitting the detection optical signal into a detection space and receiving an echo signal;
combining the first reference optical signal and the second reference optical signal into a reference optical signal, and performing frequency beating on the reference optical signal and the echo signal to obtain a beat frequency signal;
determining velocity information of a detected target based on a first frequency point located in a velocity frequency interval among two frequency points resolved from the beat frequency signal, and determining distance information of the detected target based on a second frequency point located in a distance frequency interval among the two frequency points, wherein the velocity frequency interval is symmetrical with respect to a frequency point for the specified frequency offset, and the velocity frequency interval and the distance frequency interval do not overlap.

2. The method according to claim 1, wherein performing delay processing on the first measurement optical signal to obtain the delayed first measurement optical signal comprises:
performing delay processing on the first measurement optical signal with a delay optical fiber to obtain the delayed first measurement optical signal.

3. The method according to claim 2, wherein a lowest frequency point of the delayed first measurement optical signal is greater than twice the specified frequency offset.

4. The method according to claim 1, wherein after performing frequency beating on the reference optical signal and the echo signal, the method further comprises:
performing fast Fourier transform on the beat frequency signal of one signal period by using a sliding window with a preset size to obtain a set of sub-frequency signals, wherein each sub-frequency signal in the set of sub-frequency signals corresponds to a signal located in the sliding window after one sliding in the beat frequency signal of the one signal period;
performing peak searching processing on the set of sub-frequency signals to obtain the first frequency point and the second frequency point.

5. The method according to claim 4, wherein after performing peak searching processing on the set of sub-frequency signals to obtain the first frequency point and the second frequency point, the method further comprises:
in a case where the detected target moves in a first direction and the sliding window is located within upward frequency sweeping interval, updating the second frequency point to be a sum of the first frequency point minus the specified frequency offset and the second frequency point minus twice the specified frequency offset;
in a case where the detected target moves in the first direction and the sliding window is located within downward frequency sweeping interval, updating the second frequency point to be a sum of the second frequency point minus twice the specified frequency offset and the first frequency point minus the specified frequency offset;
in a case where the detected target moves in a second direction and the sliding window is located within the upward frequency sweeping interval, updating the second frequency point to be a difference between the second frequency point and twice the specified frequency offset, minus a difference between the specified frequency offset and the first frequency point;
in a case where the detected target moves in the second direction and the sliding window is located within the downward frequency sweeping interval, updating the second frequency point to be a difference between the second frequency point and twice the specified frequency offset, minus a difference between the specified frequency offset and the first frequency point;
wherein the first direction is a direction along which the detected target moves away from the second light source, and the second direction is a direction along which the detected target moves towards the second light source.

6. The method according to claim 1, wherein optical power of the first measurement optical signal is greater than that of the first reference optical signal, and optical power of the second measurement optical signal is greater than that of the second reference optical signal.

7. The method according to claim 1, wherein combining the first reference optical signal and the second reference optical signal into the reference optical signal, and performing frequency beating on the reference optical signal and the echo signal comprise:
combining the first reference optical signal and the second reference optical signal into the reference optical signal by a first beam combiner; combining the reference optical signal and the echo signal by a second beam combiner, to perform frequency beating on the reference optical signal and the echo signal in the second beam combiner to obtain the beat frequency signal, wherein the beat frequency signal is split into two beams by the second beam combiner and provided to a balance detector;
after performing beat frequency on the reference optical signal and the echo signal, the method further comprises: performing photoelectric conversion and analog-to-digital conversion on the beat frequency signal in turn by the balance detector and an analog-to-digital converter to obtain the first frequency point and the second frequency point.

8. The method according to claim 1, wherein combining the delayed first measurement optical signal and the frequency-shifted second measurement optical signal into the detection optical signal, transmitting the detection optical signal into the detection space comprise:
combining the delayed first measurement optical signal and the frequency-shifted second measurement optical signal into the detection optical signal;
inputting the detection optical signal into a first port of a circulator, transmitting the detection optical signal into the detection space through a collimator connected to a second port of the circulator; or, inputting the detection optical signal into a first port of a circulator, transmitting the detection optical signal into the detection space through an optical phase array connected to a second port of the circulator.

9. The method according to claim 1, wherein a modulation signal of the first optical signal is a triangular wave signal, and a modulation signal of the second optical signal is a direct current signal.

10. The method according to claim 1, wherein the first optical signal and the second optical signal are laser signals transmitted by a frequency modulated continuous wave (FMCW) lidar, and the transmission of the laser signal is controlled in the following way:
transmitting a laser signal according to a first modulation period;
determining whether a preset scanning event occurs in the FMCW lidar;
upon determining occurrence of the preset scanning event in the FMCW lidar, switching the first modulation period to a second modulation period in response to the preset scanning event modulation using a triangular wave signal, that an echo signal of the laser signal has been received, wherein i is a positive integer, and the first time is any time in the process of the FMCW lidar transmitting an upward frequency sweeping modulation signal;
correspondingly, switching the first modulation period to the second modulation period in response to the preset scanning event comprises:
in response to the preset scanning event, switching the first modulation period to the second modulation period within the i-th modulation period, wherein the second modulation period is less than the first modulation period.

11. The method according to claim 10, wherein the preset scanning event is: in an i-th modulation period, the FMCW lidar detects, at a first time in a process of an upward frequency sweeping modulation using a triangular wave signal, that an echo signal of the laser signal has been received, wherein i is a positive integer, and the first time is any time in the process of the FMCW lidar transmitting an upward frequency sweeping modulation signal;
correspondingly, switching the first modulation period to the second modulation period in response to the preset scanning event comprises:
in response to the preset scanning event, switching the first modulation period to the second modulation period within the i-th modulation period, wherein the second modulation period is less than the first modulation period.

12. The method according to claim 11, wherein in response to the preset scanning event, switching the first modulation period to the second modulation period within the i-th modulation period comprises:
in response to the preset scanning event, starting to transmit a downward frequency sweeping modulation signal of the triangular wave signal from the first time.

13. The method according to claim 11, wherein a rate of frequency change of the upward frequency sweeping modulation signal is the same as a rate of frequency change of the downward frequency sweeping modulation signal;
a length of the second modulation period is twice a length of a time interval between the first time and a start time of the i-th modulation period.

14. The method according to claim 10, wherein the preset scanning event is a scanning angle of the FMCW lidar being switched from a first angular range to a second angular range, wherein a modulation period of a laser signal corresponding to the first angular range is different from a modulation period of a laser signal corresponding to the second angular range.

15. The method according to claim 14, wherein
the first angular range covers a non-central scanning field of view, the second angular range covers a central scanning field of view; or
the first angular range covers a central scanning field of view, the second angular range covers a non-central scanning field of view;
wherein a modulation period corresponding to the central scanning field of view is greater than a modulation period corresponding to the non-central scanning field of view.

16. The method according to claim 10, wherein the preset scanning event is: in a process of transmitting the laser signal according to the first modulation period, a distance between an obstacle scanned in an i-th modulation period and the FMCW lidar being detected to be less than a threshold;
correspondingly, switching the first modulation period to the second modulation period in response to the preset scanning event comprises:
in response to the preset scanning event, from an (i+1)-th modulation period, switching the first modulation period to the second modulation period, wherein the first modulation period is greater than the second modulation period.

17. The method according to claim 10, wherein the preset scanning event is: in a process of transmitting the laser signal according to the first modulation period, a distance between an obstacle scanned in an i-th modulation period and the FMCW lidar being detected to be greater than or equal to a threshold;
correspondingly, switching the first modulation period to the second modulation period in response to the preset scanning event comprises:
in response to the preset scanning event, from an (i+1)-th modulation period, switching the first modulation period to the second modulation period, wherein the first modulation period is less than the second modulation period.

18. An information detection system, comprising: a first light source, a second light source, a frequency shifter, a delay component, a transceiving module, and a processing module, wherein
the first light source is configured to generate a first optical signal and divide the first optical signal into a first measurement optical signal and a first reference optical signal, and the second light source is configured to generate a second optical signal and divide the second optical signal into a second measurement optical signal and a second reference optical signal;
the delay component is configured to perform delay processing on the first measurement optical signal to obtain a delayed first measurement optical signal;
the frequency shifter is configured to shift a frequency of the second measurement optical signal by a specified frequency offset to obtain a frequency-shifted second measurement optical signal;
the transceiving module is configured to combine the delayed first measurement optical signal and the frequency-shifted second measurement optical signal into a detection optical signal, transmit the detection optical signal into a detection space and receive an echo signal;
the processing module is configured to combine the first reference optical signal and the second reference optical signal into a reference optical signal, and perform frequency beating on the reference optical signal and the echo signal to obtain a beat frequency signal; determine velocity information of a detected target based on a first frequency point located in a velocity frequency interval among two frequency points resolved from the beat frequency signal, and determine distance information of the detected target based on a second frequency point located in a distance frequency interval among the two frequency points, wherein the velocity frequency interval is symmetrical with respect to a frequency point for the specified frequency offset, and the velocity frequency interval and the distance frequency interval do not overlap.

19. The information detection system according to claim 18, wherein the delay component comprises a delay optical fiber, a lowest frequency point of the delayed first measurement optical signal is greater than twice the specified frequency offset.

20. The information detection system according to claim 18, wherein the first optical signal and the second optical signal are laser signals transmitted by a FMCW lidar, and the transmission of the laser signal is controlled in the following way:
transmitting a laser signal according to a first modulation period to scan;
determine whether a preset scanning event occurs in the FMCW lidar;
upon determining occurrence of the preset scanning event in the FMCW lidar, switching the first modulation period to a second modulation period in response, and transmitting the laser signal according to the second modulation period, wherein a length of the first modulation period is different from a length of the second modulation period.
